(19) United States
(12) Patent Application Publication
(10) Pub. No.: US 2024/0166933 A1
(43) Pub. Date: May 23, 2024

(54) RADIATIVE COOLING COMPOSITIONS, PRECURSORS FOR FORMING THE COMPOSITIONS, AND COATINGS FORMED FROM THE COMPOSITIONS

(71) Applicant: University of Maryland, College Park, College Park, MD (US)

(72) Inventors: Liangbing HU, Rockville, MD (US); Xinpeng ZHAO, College Park, MD (US)

(21) Appl. No.: 18/502,740

(22) Filed: Nov. 6, 2023

Related U.S. Application Data
(60) Provisional application No. 63/503,023, filed on May 18, 2023.
(60) Provisional application No. 63/383,328, filed on Nov. 11, 2022.

(51) Int. Cl. C09K 5/14

(52) U.S. Cl. CPC C09K 5/14

(57) ABSTRACT

Radiative cooling compositions, as well as precursors for forming such compositions, are disclosed. The compositions comprise solid particles of at least a first composition (e.g., Al₂O₃), which are bound by a suitable binder (matrix or framework). During the synthesis of these compositions from a precursor, solvent of a binder-forming liquid such as water glass may be evaporated, or otherwise glass (e.g., mixed oxide) particles in the precursor may be softened and/or melted, in either case providing a binder for the solid particles. The manipulation of composition porosity, impacting mechanical strength, as well as performance characteristics (reflectance and/or emissivity), is possible through the selection of types and amounts of components, such that a suitable combination of properties can be engineered without the need for polymers or other materials that may be detrimental in terms of cost and/or stability.

### CROSS-REFERENCE TO RELATED APPLICATIONS

This application claims priority to U.S. provisional application No. 63/503,023, filed May 18, 2023, and to U.S. provisional application No. 63/383,328, filed Nov. 11, 2022, the contents of which are hereby incorporated by reference in their entireties.

### FIELD OF THE INVENTION

Aspects of the invention relate to compositions comprising solid particles (e.g., inorganic oxide particles) and a binder, which compositions provide, particularly when used as coatings, radiative cooling, such as exemplified by a combination of high solar reflectance and high infrared emissivity.

### DESCRIPTION OF RELATED ART

Approximately 10% of annual global electricity use is devoted to air conditioning of buildings, and with cooling needs projected to triple by 2050, new approaches are required to mitigate strain on the electric grid and combat global warming. Passive daytime radiative cooling technologies can reduce these energy demands by applying materials to the building envelope. To this end, various approaches have been demonstrated based on nanophotonic structures that integrate multi-layered inorganic thin films (e.g., composited ceramics and metals). Such structures require complex fabrication techniques with nanoscale-precision, (often in vacuum chambers), making them difficult and costly to scale, especially for building applications. To improve the manufacturability of daytime radiative cooling materials, researchers have demonstrated different approaches based on organic polymers, such as polymer-metal hybrid films, porous polymer coatings, polymer-dielectric paints, delignified wood, and multilayer polymer films. However, organic polymers tend to yellow and degrade over time when exposed to ambient conditions, including ultraviolet (UV) light, heat, water, and ambient chemicals (e.g., NOₓ, SOₓ, and O₃). This increases the solar absorption, thereby reducing the cooling power or even resulting in heating. In addition, the metals used in polymeric or inorganic radiative cooling structures, such as silver and aluminum, can be oxidized or sulfated by reactive chemical species and free radicals found in air, which causes a reduction in solar reflectance. Overall, a number of factors including significant fabrication complexity, poor mechanical strength, environmental instability, and unacceptable performance in terms of spectral solar reflectance and infrared emissivity have hindered the practical implementation of technologies of interest to date.

### SUMMARY OF THE INVENTION

Aspects of the invention are associated with the discovery of radiative cooling compositions, such as in the form of coatings that may be adhered to substrates, exhibiting desirable performance in terms of their ability to reflect a significant amount (e.g., >90%) of solar radiation and to emit heat through the atmospheric transparency window (8-13 μm) as long-wave infrared (LWIR) light into the cold universe (˜3° K) and thereby promote sub-ambient temperatures. In addition to building use, compositions described herein that provide passive radiative cooling may also benefit other applications, including solar cell operation, power plant condensers, cold storage, high-performance textiles for personal thermal comfort, dew collection, glacier melt mitigation, cooling of roads and sidewalks to reduce urban heat effects, and even aerospace thermal control requiring exposure to temperatures of up to 1000° C. Particular aspects relate to the implementation of a suitable precursor, such as to form a solution-processed coating of photonic “cooling glass,” as an exemplary radiative cooling composition, with this precursor and associated composition addressing key challenges presently hindering the development of other types of materials for comparable purposes. Such materials conventionally encompass polymer- and metal-based radiative cooling structures. Advantages associated with compositions described herein include high chemical and mechanical stability, straightforward scalability, aesthetic appeal through the availability of white and non-white colors, economic value, combined with excellent passive cooling performance.

In some embodiments, cooling glass, according to one type of radiative cooling composition, may

be fabricated using a simple two-step process, in which glass and Al₂O₃ particles are mixed into a slurry that can be easily painted on a substrate, followed by thermal annealing of the low melting-point glass to realize this composition. The glass particles (e.g., having a mean particle size of about 12 μm), which may have a low-softening temperature (e.g., about 350° C.) and rich infrared-active vibrational modes in the atmospheric transparency window, can serve as a binder to form a robust, porous supportive framework that can provide enhanced selective long-wave infrared light (LWIR) emission via Fröhlich resonances while scattering sunlight toward a fairly high solar reflectance. Additionally, Al₂O₃ particles (having a mean particle size of about 0.5 μm) may be mixed with the glass particles to improve solar reflectance of the formed composition, by allowing Mie scattering in the solar spectrum while also serving as an anti-sintering agent to prevent the complete densification of the glass particles, which would otherwise result in a sunlight-transparent structure. A dual-particle size design, or optionally a single particle size design utilizing a suitable binder (matrix or framework) may be used to enhance material and dimensional effects associated with passive radiative cooling, specifically combining a high spectral solar reflectance, for example greater than 0.96, with a high spectral infrared emissivity, for example about 0.95, in the atmospheric transparency window. As a result, after applying a precursor to form the coating (e.g., having a thickness of 300-800 μm) on a clay tile or other substrate, outdoor experiments demonstrate that the substrate temperature can be 3.5° C. lower than the ambient temperature (30° C.) at noon (solar irradiance of 800 W/m²) and 4° C. lower than the ambient temperature (17.5° C.) at night, even in high humidity (e.g., up to 80%). According to one example, simulations of mid-rise apartment buildings indicate that coating the radiative cooling composition on roofing can reduce annual CO₂ emissions by 10% (about 8 tons) due to decreased cooling needs. In addition to excellent performance, radiative cooling compositions described herein can exhibit a high adhesion strength to substrates (e.g., tile, brick, glass) and maintain high solar reflectance even when exposed to harsh environments, including water, UV, soiling, and ultra-high temperatures (e.g., up to 1000° C.). Representative coating compositions therefore can provide a simple, scalable, cost-effective, and environmentally stable glass-containing material for passive radiative cooling. The associated energy reduction can mitigate global warming, as well as improve residential comfort.

Representative radiative cooling compositions may be in the form of environmentally stable glass coatings for daytime passive radiative cooling. For example, a radiative cooling composition (e.g., coating) on a ceramic roofing tile can effectively reflect solar radiation (0.3-2.5 μm) and emit infrared (thermal) radiation to the cold sky through the atmospheric transparency window. Such compositions may advantageously have a porous structure (e.g., a porosity of 50%, referring to the condition at which 50% of the volume of the structure contains non-solid voids), in which low-melting-point glass particles (e.g., particle size of about 6 μm, and 33 vol-%) are partially sintered to form a matrix or framework, also referred to as a binder, which is decorated with Al₂O₃ particles (e.g., particle size of about 0.5 μm, and 17 vol-%). The characteristic size of glass clusters after sintering may be increased (e.g., to about 12 μm). In terms of the optical functionality of the glass particles and Al₂O₃ particles in certain radiative cooling compositions, scattering and absorption efficiencies as a function of wavelength for various solid particles in these compositions, such as glass and Al₂O₃, may be determined based on the Lorenz-Mie theory. A dual-particle design can maximize material and dimensional effects associated with passive radiative cooling, specifically high reflectance in the solar spectrum and high emissivity in the atmospheric transparency window. As an alternative to this dual-particle design, a single type of solid particle, such as a metal oxide particle having a characteristic average particle size (e.g., from about 0.3-20 μm), may be consolidated with a suitable binder to achieve important performance criteria described herein.

Particular embodiments of the invention (e.g., relating to a single-particle design, a dual-particle design, or a multi-particle design) are directed to a precursor for forming a radiative cooling composition, the precursor comprising: (a) solid particles of at least a first composition, for example comprising an inorganic oxide, nitride, carbide, sulfate, or carbonate, and (b) a binder-forming liquid (e.g., comprising a solvent) or a binder-forming solid (e.g., in a particulate/powder form). The binder-forming liquid or binder-forming solid may be, more particularly, an inorganic binder-forming liquid or an inorganic binder-forming solid, with examples of these including a silicate binder-forming liquid or a silicate binder-forming solid (e.g., water glass in liquid or solid form).

In other particular embodiments (e.g., relating to a dual-particle design or a multi-particle design), such precursor may comprise (a) solid particles of a first composition, for example comprising an inorganic oxide, nitride, carbide, sulfate, or carbonate, and (b) solid particles of a second composition different from the first composition, with the second composition being a glass, and optionally (c) a solvent. The solvent may, for example, comprise water, a hydrocarbon (e.g., an alkane such as hexane), or an oxygenated hydrocarbon (e.g., an alcohol such as ethanol). In more particular embodiments, solid particles of the first composition may be nanoparticles or microparticles (e.g., having an average particle size from about 0.1 μm to about 10 μm), and, optionally, solid particles of the second composition may have a larger average particle size, relative to that of particles of the first composition. Whether or not their average particle size is larger, solid particles of the second composition may have an average particle size, in some embodiments, from about 1 μm to about 20 μm. The solid particles of the second composition may form (e.g., through softening, melting, and/or sintering at elevated temperatures) a binder (matrix or framework) for the solid particles of the first composition. Alternatively, the precursor may comprise (d) a binder-forming liquid or a binder-forming solid as described herein with respect to precursors relating to a single-particle design.

Further particular embodiments of the invention are directed to methods for forming a coating composition on a substrate. Representative methods comprise (a) applying a precursor having any one or more characteristics described herein (e.g., if initially in slurry form) to the substrate, optionally following combining the precursor (e.g., if initially in dry form) with a solvent as described herein. Prior to the step of applying, the precursor, if initially in slurry form, may be, or may have been, subjected to mixing to promote uniform blending (homogeneity) of the precursor and/or adjust the particle size and/or particle size distribution of solid particles contained in the slurry (e.g., solid particles of a first composition and/or solid particles of a second composition). More generally, any type of mechanical agitation or energy input to cause blending of the precursor components may be employed. In other embodiments, prior to the step of applying, the precursor, if initially in dry form, may be combined with a solvent as described herein and then subjected to mixing, or more generally any type of mechanical agitation/energy input to cause blending of the precursor components. According to any such methods, following the step (a) of applying the precursor to the substrate, these methods may further comprise (b) drying the precursor, or allowing the precursor to dry, in either case resulting in evaporation of the solvent. The steps (a) and (b) in combination, optionally with any further steps, form the coating composition.

In the particular case of a precursor relating to a dual-particle design or a multi-particle design and comprising (a) solid particles of a first composition, as described herein and (b) solid particles of a second composition different from the first composition, as described herein, representative methods for forming a coating composition on a substrate may comprise a step (a) of applying the precursor to the substrate, optionally following combining the precursor with a solvent (e.g., water). As described above, the precursor may be, or may have been, subjected to mixing or more generally any type of mechanical agitation/energy input to cause blending of the precursor components. Representative methods may further comprise (b) heating the precursor to a temperature that is at or above a softening temperature of the second composition, thereby forming a binder (matrix or framework) for the solid particles of the first composition. In the case of such precursors having a dual-particle design or multi-particle design, in addition to a solvent, step (b) may, more particularly, comprise both (b1) drying the precursor, or allowing the precursor to dry, in either case resulting in evaporation of the solvent, as described above, followed by (b2) heating the precursor to a temperature that is at or above the softening temperature of the glass.

With respect to any methods described herein for forming a coating composition, such methods may further comprise applying a dense, clear protective layer (e.g., a glass layer) on the coating composition, to form an overlaid coating composition (e.g., a glass overlaid composition). This protective layer may be formed from a binder-forming liquid (e.g., silicate binder-forming liquid such as water glass) as described herein, with such binder-forming liquid lacking, or having a substantial absence of, solid particles of the first and/or second composition, or at least having a reduced content (weight percentage) of such solid particles, relative to the content(s) (weight percentage(s)) of such solid particles in the coating composition. The protective layer may alternatively be formed from a glass having a relative low softening and/or melting temperature as described herein. In representative embodiments, the protective layer may comprise less than about 10 wt-%, less than about 5 wt-%, or less than about 1 wt-% of solid particles. The protective layer may comprise a pigment as described herein, to obtain desired aesthetic effects and/or promote desired performance characteristics (reflectance and/or emissivity).

Yet further particular embodiments are directed to coating compositions and overlaid coating compositions, formed by methods described herein, with such compositions typically being formed on a substrate to which the beneficial effects of radiative cooling are imparted. The coating composition or overlaid coating composition (excluding the protective layer) may have a porosity of at least about 2% (e.g., from about 2% to about 50% or from about 2% to about 25%), or at least about 10% (e.g., from about 10% to about 30%) to desired mechanical strength and desired performance characteristics (reflectance and/or emissivity). In order to achieve desired porosity, including such levels to achieve such desired mechanical strength and/or photonic performance, the amount of binder in the coating composition may be adjusted. With all other factors (e.g., solid particle type(s), solid particle size(s), etc.) being equal, increasing the amount of binder decreases porosity, increases mechanical strength, and decreases reflectance. In representative embodiments, to achieve an advantageous balance of properties, coating compositions or overlaid coating compositions (excluding the protective layer) may comprise the binder (e.g., silicate binder such as sodium silicate formed from water glass) in an amount from about 10 wt-% to about 60 wt-%, such as from about 10 wt-% to about 30 wt-%, relative to the weight of the coating composition. This likewise corresponds to the same content of binder, on a solvent-free basis (i.e., excluding the solvent) in precursors described herein, relative to the total weight of precursor, also on a solvent-free basis.

Important aspects of the invention relate to the discovery of particular radiative cooling compositions, as well as precursors that are engineered to form these compositions, having a surprising and unexpected combination of performance characteristics, including reflectance and emissivity, together with suitable mechanical strength and stability to withstand a wide range of conditions to which the compositions may be exposed continuously and/or under which the compositions may be applied at least temporarily. The compositions and precursors can be prepared in an economical manner, especially compared to systems proposed to date for achieving similar effects.

These and other embodiments, aspects, and advantages relating to the present invention are apparent from the following Detailed Description.

### BRIEF DESCRIPTION OF THE DRAWINGS

A more complete understanding of exemplary embodiments of the present invention and the advantages thereof may be acquired by referring to the following description in consideration of the accompanying figures.

FIG. 1 provides SEM images of a radiative cooling composition of a dual-particle design, which show smaller Al₂O₃ nanoparticles and larger glass particles that are bound with a binder.

FIG. 2 provides SEM images of a radiative cooling composition of a dual-particle design as described with respect to FIG. 1, but also being overlaid with a transparent glass overlayer, formed of the binder without solid particles.

FIG. 3 illustrates properties of solar reflectance, averaged infrared emissivity in the wavelength range of 8-13 μm, and mechanical strength, of representative radiative cooling compositions of bound Al₂O₃ nanoparticles (0.5 μm average diameter) and glass particles (7 μm average diameter), as a function of the mass fraction of sodium silicate binder formed from water glass. SEM images of the compositions are also provided.

FIG. 4 illustrates properties as described above with respect to FIG. 3, of representative radiative cooling compositions of bound Al₂O₃ microparticles (4 μm average diameter), as a function of the mass fraction of sodium silicate binder formed from water glass. SEM images of the compositions are also provided.

FIG. 5 illustrates properties as described above with respect to FIG. 3, of representative radiative cooling compositions of bound glass particles (7 μm average diameter), as a function of the mass fraction of sodium silicate binder formed from water glass. SEM images of the compositions are also provided.

FIG. 6 illustrates properties as described above with respect to FIG. 3, of representative radiative cooling compositions of bound Al₂O₃ particles (0.5 μm average diameter), as a function of the mass fraction of sodium silicate binder formed from water glass. SEM images of the compositions are also provided.

FIG. 7 illustrates properties as described above with respect to FIG. 3, of representative radiative cooling compositions of bound Al₂O₃ microparticles (4 μm average diameter) and glass microparticles (7 μm average diameter), as a function of the mass fraction of sodium silicate binder formed from water glass.

FIG. 8 illustrates a representative method of making a coating, according to which solvent is mixed with glass particles and Al₂O₃ particles that have been ball milled to create a slurry, the slurry is applied to a substrate, dried ambiently, and then heat is applied to the surface to melt the glass particles.

FIG. 9 illustrates another representative method of making a coating, according to which the solvent is mixed with a binder and with glass particles and Al₂O₃ particles that have been ball milled to create a slurry, the slurry is applied to a substrate and dried ambiently.

FIG. 10 illustrates a non-limiting design principle associated with an environmentally stable glass coating for daytime passive radiative cooling.

FIG. 11 illustrates a representative manufacturing process of a composition, utilizing external heating.

FIG. 12 is a schematic of one possible external heating step used in the fabrication of a radiative cooling glass coating composition.

FIG. 13 provides an SEM image of a glass and Al₂O₃ particle mixture after sintering at about 600° C. for 1 min. After this heat treatment, the Al₂O₃ particles are dispersed with the softened and merged glass particles, forming a cohesive microporous structure.

FIG. 14 provides an SEM image of the cross-sectional morphology of a representative microporous coating after sintering at about 600° C. This exemplary coating has a thickness of about 550 μm and has a porous structure, as shown.

FIG. 15 provides an SEM and an analysis of a representative microporous coating, after sintering at about 600° C.

FIG. 16 illustrates the effect of the Al₂O₃ particle mass fraction on the solar reflectance of the radiative cooling glass coating with a thickness of about 550 μm.

FIG. 17 illustrates, in one embodiment, a minimal effect of the mass fraction of Al₂O₃ particles on the infrared emissivity of the radiative cooling glass coating with a thickness of about 550 μm.

FIG. 18 illustrates the effect of the thickness of a radiative cooling glass coating on its solar reflectance, according to one embodiment in which the mass fraction of the Al₂O₃ particles is about 50 wt-%.

FIG. 19 provides a representative spectrum of a coating composition for radiative cooling, in addition to the measured solar reflectance and infrared emissivity, over the range of 0.3-20 μm, at a coating thickness of about 550 μm.

FIG. 20 illustrates process compatibility with a wide range of particles.

FIGS. 21 and 22 illustrate measured cooling performances in the daytime and nighttime, respectively.

FIG. 23 provides an SEM image of a radiative cooling glass coating, covered by a dense and transparent protective layer of thin solid glass with a thickness of about 20 μm.

FIG. 24 illustrates a comparison between an original radiative cooling glass coating and the radiative cooling glass coating being covered with transparent protective glass.

FIG. 25 illustrates the geometric structure of a colored glass-ceramic daytime radiative cooling coating.

FIG. 26 illustrates manufacturing and optical characterization of colored radiative cooling structures, and illustrates that colored samples achieve high solar reflectivity.

FIG. 27 illustrates the influence of dye concentration on the solar reflectance of colored radiative cooling coatings.

### DETAILED DESCRIPTION

Embodiments of the invention are directed to coating compositions, as well as precursors used to form these compositions, having advantageous performance characteristics and mechanical properties that are particularly suitable for use as radiative cooling compositions. Preferably, such coating compositions and precursors are engineered with a combination of these performance characteristics and mechanical properties. Of particular significance in terms of one performance characteristic is “spectral solar reflectance,” also referred to herein as “solar reflectance” or “reflectance,” which refers more particularly to spectrally-averaged reflectance of radiation in the solar region, over wavelengths in the range of 0.3-2.5 μm. Spectrally-dependent values of this performance characteristic, referenced herein, are determined in accordance with ASTM E903-20 (Standard Test Method for Solar Absorptance, Reflectance, and Transmittance of Materials using Integrating Spheres). Also of particular significance in terms of another performance characteristic is “spectral infrared emissivity,” also referred to herein as “infrared emissivity” or “emissivity,” which refers more particularly to the spectrally-averaged emissivity of radiation in atmospheric transparency window, over wavelengths in the range of 8-13 μm. Spectrally-dependent values of this performance characteristic, referenced herein, are determined in accordance with ASTM E408-13(2019) (Standard Test Methods for Total Normal Emittance of Surfaces using Inspection-Meter Techniques). Using the values obtained from these ASTM standards, the solar reflectance (e.g., 0.95) and emissivity (e.g., 0.95) are determined according to the following method:

The⋅spectrally-averaged⋅solar⋅reflectance, γ, ⋅can⋅be⋅evaluated⋅using⋅the⋅spectral⋅solar⋅radiation⋅intensity⋅of⋅air⋅mass˜1.5⋅(I_{sol,λ},⋅M1.5)⋅as⋅a⋅weighting⋅factor, ⋅as⋅given⋅by, ¶

$$γ = \frac{{\int }_{0.3 μ m}^{2.5 μ m} {γ}_{λ} {I}_{sol \cdot λ} d λ}{{\int }_{0.3 μ m}^{2.5 μ m} {I}_{sol \cdot λ} d λ} \qquad ( S4 ) ¶$$

where ⋅γ_{λ}⋅is⋅spectral⋅reflectance⋅in⋅solar⋅region,¶

The⋅spectrally-averaged⋅emissivity, ⋅α, ⋅can⋅be⋅evaluated⋅using⋅the⋅spectral⋅blackbody⋅emissive⋅power⋅in⋅the⋅8-13 μm⋅range⋅as⋅a⋅weighting⋅factor. ⋅This⋅is⋅given⋅by,¶

$$α = \frac{{\int }_{8 μ m}^{13 μ m} {α}_{λ} {I}_{b λ} d λ}{{\int }_{8 μ m}^{13 μ m} {I}_{b λ} d λ} \qquad ( S5 ) ¶$$

where,

$${I}_{b λ} = \frac{2 {hc}_{0}^{2}}{{λ}^{5} [ exp ( {hc}_{0} / λ {k}_{b} T ) - 1 ]} ,$$

h=6.6.25×10⁻³⁴ J⋅s⋅is⋅the⋅universal⋅Plank⋅constant, ⋅k_{b}=1.381×10⁻²³ J/K is⋅the⋅Boltzmann·constant, ⋅and⋅c₀=2.998×10⁸ m/s is⋅the⋅speed⋅of⋅light⋅in⋅vacuum.¶

The terms “substantial” and “substantially,” as used herein, refers to an extent of at least 95%. For

example, the phrase “substantially all” may be replaced by “at least 95%.” The phrase “substantial absence” refers to the presence of not more than 5% of a reference (e.g., initially present) amount.

Representative coating compositions may have, and representative precursors may form coating compositions having, a spectral solar reflectance of at least about 0.6 (e.g., from about 0.6 to 1.0), at least about 0.7 (e.g., from about 0.7 to 1.0), at least about 0.8 (e.g., from about 0.8 to 1.0), or at least about 0.9 (e.g., from about 0.9 to 1.0). Alternatively to, but preferably in combination with, such values of spectral solar reflectance, representative coating compositions may have, and representative precursors may form coating compositions having, a spectral infrared emissivity of at least about 0.75 (e.g., from about 0.75 to 1.0), at least about 0.80 (e.g., from about 0.80 to 1.0), at least about 0.85 (e.g., from about 0.85 to 1.0), at least about 0.90 (e.g., from about 0.90 to 1.0), or at least about 0.95 (e.g., from about 0.95 to 1.0).

Of particular significance in terms of mechanical properties are those which provide a qualitative or quantitative measurement of the mechanical integrity or strength with which the coating is adhered to a substrate or by which the coating resists deformation, scratching, or breakage upon being subjected to external, impacting forces. A particular mechanical integrity or strength property is determined in accordance with ASTM D3359-22 (Standard Test Methods for Rating Adhesion by Tape Test). Optionally in combination with values of spectral solar reflectance and/or spectral infrared emissivity as described herein, representative coating compositions may have, and representative precursors may form coating compositions having, an adhesion rating of at least 3 (e.g., from 3 to 5) or at least 4 (e.g., from 4 to 5). Adhesion ratings of less than 2 may be associated with a qualitative assessment of unacceptable ease of peeling from the substrate, when subjected to peeling forces of applied tape. Another particular mechanical integrity or strength property is determined in accordance with ASTM D3363-22 (Standard Test Method for Film Hardness by Pencil Test). Optionally in combination with values of spectral solar reflectance and/or spectral infrared emissivity as described herein, and further optionally in combination with an adhesion rating, as described herein, representative coating compositions may have, and representative precursors may form coating compositions having, a film hardness of at least H (from H to 6H), at least 2H (from 2H to 6H), or at least 3H (from 3H to 6H).

A convenient reference sample of a coating composition for determining its spectral solar reflectance, its spectral infrared emissivity, or its mechanical properties as described herein has a thickness of 500 μm on a metallic surface, such as an aluminum surface.

Mechanical properties are influenced by the porosity or void fraction (due to pores in) of a given coating composition, with higher levels of porosity leading to reduced adhesive strength and/or reduced resistance to deformation, scratching, and/or breakage. Porosity can be determined, for example, by scanning electron microscopy (SEM) imaging of a cross section of the composition, or by other methods known in the art. To ensure sufficient mechanical integrity or strength, representative coating compositions may have, and representative precursors may form coating compositions having, a porosity that is generally less than about 60% (e.g., from about 5% to about 60%), typically less than about 50% (e.g., from about 5% to about 50%), and often less than about 40% (e.g., from about 5% to about 40%). In some embodiments, given that sufficient solid particles may be required to achieve desired performance characteristics (reflectance and/or emissivity), including those described herein, and further given that solid particles contribute to porosity, representative coating compositions have, and representative precursors may form coating compositions having, a porosity of at least about 10% (e.g., from about 10% to about 60%, from about 10% to about 40%, or from about 10% to about 30%). As described above, a desired porosity may be obtained by adjusting the amount of binder in the coating composition, which amount may generally correspond to that of the binder-forming liquid on a solvent-free basis, or otherwise to that of the binder-forming solid, in the precursor. Accordingly, in representative embodiments, the binder-forming liquid may be present in a precursor, on a solvent-free basis (i.e., excluding the solvent) in an amount of generally less than about 60 wt-% (e.g., from about 5 wt-% to about 60 wt-%), typically less than about 45 wt-% (e.g., from about 5 wt-% to about 45 wt-%), and often less than about 30 wt-% (e.g., from about 10 wt-% to about 30 wt-%). In further representative embodiments, therefore, the binder may be present in a coating composition in an amount corresponding to any of these ranges of weight percentages, given the absence or substantial absence of solvent generally, in corresponding, formed coating compositions.

Insofar as (i) porosity and therefore mechanical properties of coating compositions are impacted by the content of binder and the content of solid particles, with the former leading to decreased porosity/increased mechanical properties and the latter leading to increased porosity/decreased mechanical properties, and (ii) solid particles in the coating compositions are necessary for imparting desired photonic performance characteristics (reflectance and/or emissivity), those having skill in art, with the knowledge gained from the present specification, can effectively engineer coating compositions, as well as precursors for forming these compositions, to achieve desired performance characteristics and mechanical properties for any given binder and any given type(s), size(s), and amount(s) of solid particles, as well as optionally other components, in these compositions. In particular embodiments, for example, representative coating compositions may have a combination of a spectral solar reflectance of at least about 0.9 and a spectral solar emissivity of at least about 0.85, optionally further in combination with mechanical properties described herein. Correspondingly, representative precursors, when applied (e.g., to a substrate) and subjected to drying to remove least a portion (e.g., at least about 50%), and preferably all or substantially all, of the solvent and/or other vaporizable components of such precursors, form coating compositions having these performance characteristics, optionally further in combination with mechanical properties described herein.

Embodiments of the invention are directed to precursors, such as those for forming radiative cooling compositions having performance characteristics and/or mechanical properties as described herein. The precursors may comprise (a) solid particles of at least first composition and (b) a binder-forming liquid or a binder-forming solid (e.g., an inorganic binder-forming liquid or inorganic binder-forming solid, such as a silicate binder-forming liquid or a silicate binder-forming solid). In the case of a binder-forming liquid, the precursor may be in the form of a slurry having the binder-forming liquid as a continuous liquid phase and the solid particles as discontinuous solid phase. The binder-forming liquid will generally include a solvent that, upon removal by evaporation of at least a portion thereof, and preferably all or substantially all of the solvent, provides the binder of the formed coating composition. In the case of a binder-forming solid, the addition of a solvent as described herein can convert this binder-forming solid into a binder-forming liquid, and thereby convert the precursor from the form of solid components (e.g., a mixture of solids (a) and (b)) into the form of such slurry. When such precursors are (i) applied to a substrate, optionally following combining these precursors with a solvent such as water or an alcohol (e.g., in the case of precursors having a binder-forming solid), and/or optionally following subjecting the precursor to mixing, and then (ii) dried, or allowed to dry, in either case causing solvent to evaporate, a coating composition is formed. This coating composition includes the solid particles initially present as component (a) of the precursor, being bound by the binder (matrix or framework for the solid particles) that results from the removal (e.g., by evaporation) of solvent initially present in the binder-forming liquid, or initially added to the binder-forming solid.

In this regard, depending on the manner in which the precursor is applied to the substrate, the precursor, or slurry formed upon the addition of a solvent, may be considered a paint composition or an ink composition. For example a precursor as a paint composition may be applied to the substrate by spraying or brushing. A precursor as an ink composition may be applied by printing, such as by using inkjet printing or intaglio printing, for example gravure printing, techniques.

The term “solvent” refers to a room-temperature liquid component of a precursor, which can be vaporized by heating, or otherwise can be allowed to evaporate under ambient conditions, in the process of forming a coating composition, by drying a precursor. A coating composition thereby results from the removal of at least a portion (e.g., at least about 50%) of the solvent, and preferably from the removal of all or substantially all of the solvent. Representative solvents, such as in the case of being a component of a binder-forming liquid, may provide a continuous liquid phase, or carrier, for a precursor that is a slurry having discreet solid particles. It can therefore be appreciated that, with respect to a description of weight percentages on a solvent-free basis of a given component (e.g., solid particles having a first composition, solid particles having a second composition, binder such as sodium silicate) of the precursor, this amounts to a description of the same weight percentages of such component of a coating composition formed by that precursor. Conversely, with respect to a description of weight percentages of a given component of the coating composition, this amounts to a description of weight percentages on a solvent-free basis of such component of a precursor used to form that coating composition. Solvents, or at least one or more compounds present in solvents (and possibly all compounds), preferably have a normal boiling point of less than about 200° C., such as a normal boiling point of 100° C. or less. Particular solvents may comprise water, a hydrocarbon (e.g., a C₄-C₁₀ alkane hydrocarbon), or an oxygenated hydrocarbon (e.g., an alcohol, an ether, a ketone, an aldehyde, or a carboxylic acid, any of which may have from 1 to 8 carbon atoms). Representative alcohols include methanol, ethanol, and propanol; representative ethers include dimethyl ether, methylethyl ether, and dimethyl ether; representative ketones include acetone, methylethyl ketone, and diethyl ketone; representative aldehydes include formaldehye and acetaldehyde; representative carboxylic acids include acetic acid and propionic acid. Solvents may have combinations of such compounds, or otherwise may consist of, or consist essentially of, a single compound. Preferred solvents comprise, consist of, or consist essentially of, water. Other preferred solvents comprise, consist of, or consist essentially of, an alcohol such as methanol or ethanol.

A precursor (e.g., slurry, in the form of a paint composition or ink composition, or alternatively in the form of a mixture of solids that can be converted into such slurry by the addition of a solvent) for forming a radiative cooling composition may therefore comprise (a) solid particles having at least a first composition. These solid particles may comprise, or may consist of, an inorganic oxide, nitride, carbide, sulfate, or carbonate. According to particular embodiments, solid particles having the first composition may comprise, or consist of, Al₂O₃, SiO₂, BN, BaSO₄, CaCO₃, ZnO, TiO₂, or MgO. Particles, according to particular embodiments, may comprise, or consist of, inorganic oxides, such as Al₂O₃, SiO₂, ZnO, TiO_{2,} and MgO. Particles comprising, or consisting of, Al₂O₃ are exemplary in view of their spectral properties. Precursors having only a single type of solid particle (e.g., the solid particles of the precursor have essentially the same chemical composition and optionally provide a unimodal size distribution) may be considered “single-particle design” types of precursors that form corresponding “single-particle design” coating compositions.

Whether or not present in single-particle design type precursor or corresponding coating composition, the solid particles having the first composition may be nanoparticles or microparticles. For example, such solid particles may have an average particle size from about 10 nanometers (nm) to about 20 microns (μm), such as from about 10 nm to about 10 μm, from about 10 nm to about 5 μm, from about 10 nm to about 1 μm, from about 0.1 μm to about 20 μm, from about 0.1 μm to about 10 μm, from about 0.1 μm to about 5 μm, or from about 0.1 μm to about 1 μm. In other embodiments, solid particles having the first composition may have other average particle sizes, including larger average particle sizes. These may be, for example, in a range from about 1 μm to about 100 μm, from about 2 μm to about 100 μm, from about 5 μm to about 100 μm, from about 10 μm to about 100 μm, from about 25 μm to about 100 μm, from about 50 μm to about 100 μm, from about 1 μm to about 50 μm, from about 2 μm to about 50 μm, from about 5 μm to about 50 μm, from about 10 μm to about 50 μm, from about 25 μm to about 50 μm, from about 1 μm to about 25 μm, from about 2 μm to about 25 μm, from about 5 μm to about 25 μm, from about 10 μm to about 25 μm, from about 2 μm to about 20 μm, or from about 5 μm to about 15 μm. Solid particles having the first composition may have a unimodal size distribution, with the continuous particle size histogram displaying a single peak. Optionally, two or more sizes of solid particles having the first composition may be used in a given precursor and corresponding radiative cooling composition, resulting in a bi-modal size distribution or multi-modal size distribution of the solid particles. For example, a combination of (i) the solid particles having an average particle size representative of “nanoparticles or microparticles” as described above (with any of the specific, stated particle size ranges), with (ii) the solid particles having an average particle size characterized by “other average particles sizes, including larger average particle sizes,” as described above (with any of the specific, stated particle size ranges), may result in a bimodal size distribution, with peaks corresponding to, or corresponding approximately to, the two or more average particle sizes. The solid particles (i) and solid particles (ii) may be present in the precursor, and consequently in a corresponding coating composition, in a weight ratio of (i):(ii) from about 100:1 to about 1:100, from about 10:1 to about 1:10, from about 5:1 to about 1:5, or from about 2:1 to about 1:2.

When used to characterize solid particles described herein, the terms “size” and “diameter,” refer to their average particle size, or D50 particle size, which is a term used in the art to designate the particle size at which 50% of the particles are smaller and 50% of the particles are larger, as determined by methods known in the art.

In addition to (a) solid particles having at least a first composition as described above, the precursor may further comprise (b) a binder-forming liquid or a binder-forming solid, with the latter possibly being in a particulate or powder form, such that the precursor as a whole could be in the form of a mixture of solid particles or a mixture of solid particles and powder, to be converted into a slurry by the addition of a solvent. For example, according to a particular embodiment, a binder-forming solid may be, or may comprise, a solid alkali metal silicate, such as sodium silicate or potassium silicate that, when combined with water, may provide a binder-forming liquid as an alkali metal silicate solution (e.g., a sodium silicate solution or water glass, or a potassium silicate solution), with the binder-forming liquid having the added solvent as a component and thereby converting the precursor, as a mixture of solids, into a slurry. Other types of binder-forming solids include alkaline earth metal silicates and their hydrated forms, such as hydrated magnesium silicate or talc (Mg₃Si₄O₁₀(OH)₂). The precursor may comprise a binder-forming liquid, as described herein, with the solvent already being present as a component of this binder-forming liquid and the precursor already being a slurry. Preferred binder-forming solids and binder-forming liquids are, respectively, silicate binder-forming solids and silicate binder-forming liquids, having the capability, upon addition and/or (subsequent) removal (e.g., by evaporation) of solvent, to provide a silicate binder for solid particles (e.g., in the form of a continuous matrix or framework), such as an alkali metal silicate binder or an alkaline earth metal silicate binder. An exemplary silicate binder-forming liquid in this regard is water glass, which refers to a solution of sodium silicate (Na₂(SiO₂)ₙO) that forms a solid sodium silicate binder upon evaporation of water as the solvent, and as a component, of this binder. As is understood in the art, water glass can be synthesized by roasting varying amounts of soda ash (sodium carbonate, Na₂CO₃) and silica sand as an available source of silica, SiO₂. The roasting process may be carried out in a furnace at approximately 1,000° C.-1,400° C. Following roasting, the resulting material is dissolved in hot water within pressurized reactors to yield water glass. Another exemplary silicate binder-forming liquid is a solution of potassium silicate (K₂(SiO₂)ₙO) that forms solid potassium silicate upon evaporation of water as the solvent, and as a component, of this binder. Accordingly, sodium silicate (Na₂SiO₃) itself (e.g., in particulate, granular, or powder form) is an exemplary binder-forming solid that, when combined with water as a solvent, can provide water glass. Likewise, potassium silicate (K₂SiO₃) and magnesium silicate (MgSiO₃), as well as their hydrated forms, are exemplary binder-forming solids and components of binder-forming liquids (obtained upon adding a solvent). In some embodiments, binder-forming solids and binder-forming liquids may be, or may comprise as a component (e.g., together with added solvent), an aluminosilicate, such as a clay, with kaolinite (Al₂O₃(SiO₂)₂) and metakalonite (Al₂Si₂O₇) being exemplary. With respect to any silicate binder-forming solid being used, the precursor may further comprise a solvent (e.g., water or an alcohol) and may therefore be a slurry of solid particles in that solvent.

In general, representative binder-forming solids and binder-forming liquids have the capability upon addition and/or (subsequent) removal (e.g., by evaporation) of solvent, to provide a binder in the form of a continuous solid matrix or framework for the solid particles, preferably as discreet solid bodies being dispersed relatively uniformly throughout the resulting coating composition. Such binder-forming solids may, as described herein, be present in a precursor as a solubilized component (dissolved in a solvent as described herein), or otherwise as a component of a slurry, which may be used to characterize the form of the precursor. In the case of being solubilized components, representative binder-forming solids extend to any liquid-dissolvable inorganic binders that provide silicate-based binders including sodium metasilicate pentahydrate or calcium silicate binders such as Portand cement. More generally, representative binder-forming liquids and binder-forming solids include those known for use in the formation of inorganic binders including ceramic binders, which extend without limitation to silicate-based binders. These include, for example, sulfate-based binders, alumina-based binders (e.g., hydratable alumina such as Alphabond™ 300), and phosphate-based binders (e.g., mixtures of phosphoric acid and phosphate salts). Representative binder-forming liquids and solids may also comprise, or consist of, materials known for use in aqueous and organic sol-gel processing. According to particular embodiments, representative precursors may comprise two or more (e.g., in the form of a mixture) of any of the binder-forming liquids and solids described herein, such as in the case of using talc and/or a clay as an additive in combination with another binder-forming liquid and/or solid, such as a silicate binder-forming liquid and/or solid as described above. Metallic salts of fatty acids, such as cobalt or manganese linoleates, or other types of salts that are water-soluble and that can yield a continuous solid matrix or framework upon evaporation of the water, may likewise be used as binder-forming liquids and solids, or components thereof, or optionally used as additives thereof.

According to some embodiments, precursors and corresponding coating compositions formed

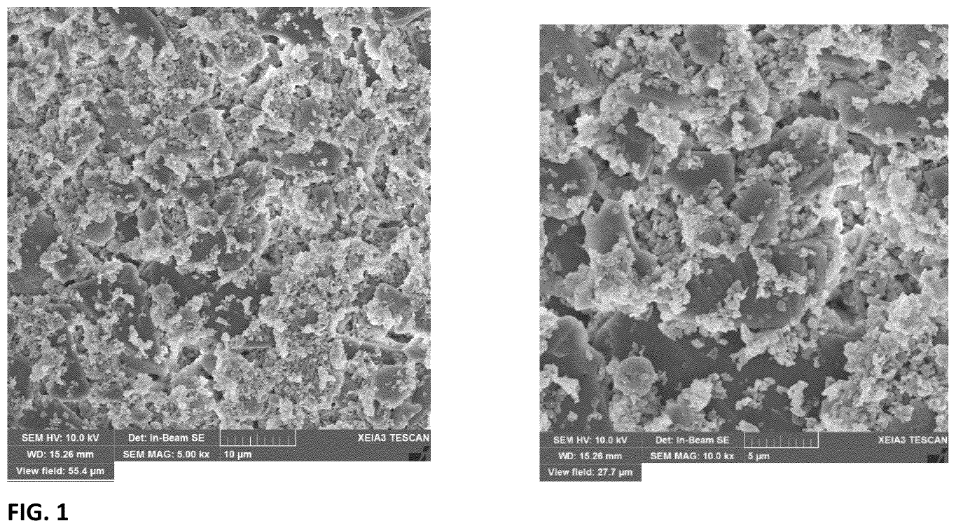

from these precursors, in addition to (a) solid particles having at least a first composition as described above, and (b) a binder-forming liquid or a binder-forming solid as described above, may further comprise solid particles having a second composition different from the first composition. For example, solid particles having the first composition may have an average particle size representative of “nanoparticles or microparticles” as described above (with any of the specific, stated particle size ranges), and/or solid particles having the second composition may have an average particle size characterized by “other average particles sizes, including larger average particle sizes,” as described above (with any of the specific, stated particle size ranges). A combination of (i) the solid particles having at least a first composition and (ii) solid particles having at least a second composition may be present in the precursor, and consequently in a corresponding coating composition, in a weight ratio of (i):(ii) from about 100:1 to about 1:100, from about 10:1 to about 1:10, from about 5:1 to about 1:5, or from about 2:1 to about 1:2.

Whereas, as described above, precursors having a single type of solid particle may be considered “single-particle design” types of precursors that form corresponding “single-particle design” coating compositions, precursors having two types of solid particles (e.g., solid particles having two distinct chemical compositions and generally two distinct size distributions) may be considered “dual-particle design” types of precursors that form corresponding “dual-particle design” coating compositions. For example, FIG. 1 provides SEM images of a radiative cooling composition of a dual-particle design, which show smaller Al₂O₃ nanoparticles (approx. 0.5 μm diameter) and larger glass particles (approx. 12 μm diameter) that are bound with a binder. Precursors having multiple types of solid particles (e.g., solid particles having three or more distinct chemical compositions and generally three or more, corresponding distinct size distributions) may be considered “multi-particle design” types of precursors that form corresponding “multi-particle design” coating compositions.

Regardless of the number of types of solid particles, these solid particles, together with the solvent-free portion of the binder-forming liquid, contribute to the total solids content of the precursor. In embodiments utilizing a binder-forming liquid with a solvent, or otherwise in embodiments generally in which the precursor is a slurry, this slurry may have a total solids content of at least about 5 wt-% (e.g., from about 5 wt-% to about 85 wt-% or from about 5 wt-% to about 50 wt-%), at least about 20 wt-% (e.g., from about 20 wt-% to about 85 wt-% or from about 20 wt-% to about 50 wt-%), or at least about 50 wt-% (e.g., from about 50 wt-% to about 85 wt-%). The contribution of the binder on a solvent-free basis, to the total solids content, of precursors in slurry form or solid form is described above, and in this regard the binder on a solvent-free basis may represent from about 10 wt-% to about 60 wt-%, such as from about 10 wt-% to about 30 wt-%, or otherwise may represent from about 20 wt-% to about 50 wt-% or from about 45 wt-% to about 70 wt-%, of the weight of the precursor on a solvent-free basis. According to particular embodiments, the one or more types of solid particles may represent the balance, or substantially the balance, of the precursor on a solvent-free basis, and therefore these one or more types of solid particles may represent the balance, or substantially the balance, of the corresponding coating compositions formed from such precursor. For example, one or more types of solid particles, together with the binder-forming solid or binder-forming liquid on a solvent-free basis, may represent at least about 85%, at least about 95%, or at least about 99%, of the weight of the precursor on a solvent-free basis, and/or the one or more types of solid particles, together with the binder of the corresponding coating composition, may represent these percentages of the weight of coating composition. In some embodiments, therefore, (i) solid particles (of one or more types), (ii) a binder-forming solid, and (iii) an optional solvent, may represent all or substantially all of the weight of a precursor. Likewise, (i) solid particles (of one or more types), and (ii) binder, may represent all or substantially all of the weight of a coating composition.

Optional components of precursors and corresponding coating compositions include pigments. For example, as pigments, representative precursors and coating compositions may further comprise a phosphor (e.g., CaAlSiN₃:Eu, (Sr,Ba)₂SiO₄:Eu, (Ce,Gd):YAG, Y₃Al₅O₁₂:Ce, Y₃(AlGa)₅O₁₂:Ce, SrSiO₄:Eu, CaAlSiN₃:Eu), and oxide (e.g., Fe₂O₃, WO₃), or a quantum dot (e.g., CdSe, CdS, ZnS) or semiconductor. Generally any oxide-containing pigment, or salts that include metal ions to impart color, may be suitable. Various pigments (coloring agents) may be present in a precursor (e.g., on a solvent-free basis), or otherwise in a coating composition, in an amount generally from about 1 wt-% to about 50 wt-%, such as from about 1 wt-% to about 20 wt-%, from about 1 wt-% to about 10 wt-%, or from about 1 wt-% to about 5 wt-%. The amount of pigment, if used, can be adjusted to achieve a desired depth of color. Advantageously, in view of the effectiveness of precursors and their corresponding coating compositions, and particularly the performance characteristics (reflectance and/or emissivity) of the latter being attained, in many cases, with only a limited number of components, such precursors and coating compositions may advantageously lack components that have conventionally proven to be problematic in terms of stability and/or mechanical integrity. For example, an organic polymer (e.g., acrylic polymer) may be absent from the precursor and coating composition.

Another type of solid particle, which may be used as solid particles having a first composition, are glass particles. Accordingly, the first composition may be a glass. Otherwise, in the case of “dual-particle design” types of precursors that form corresponding “dual-particle design” coating compositions, glass particles may be used as solid particles having the second composition, such that the second composition may be a glass, optionally with solid particles having the first composition comprising, or consisting of, an inorganic oxide, nitride, carbide, sulfate, or carbonate, as described above. For example, solid particles having the second composition may be glass powder particles. Particles having the second composition may comprise an oxide or mixed oxide glass material, characteristic of any of a number of various types of glass, such as phosphate glass, borosilicate glass, soda lime glass, etc. Any such glass particles may have an average particle size representative of “nanoparticles or microparticles” as described above (with any of the specific, stated particle size ranges), and/or solid particles having the second composition (e.g., comprising a glass) may, in preferred embodiments, have an average particle size characterized by “other average particles sizes, including larger average particle sizes,” as described above (with any of the specific, stated particle size ranges), including an average particle size that is characteristic of a powder. In more particular embodiments in which the second composition is a glass, particles having the second composition may comprise an oxide or mixed oxide glass material, such as in powder form. Specific examples of compositions that are glass, which may be in the form of glass powders, include, but are not limited to SiO₂, Al₂O₃, MgO, SiO₂—Al₂O₃—Na₂CO₃—CaO, SiO₂—Na₂O—ZnO—CaO, SiO₂—Al₂O₃—Na₂O—CaO—TiO₂, SiO₂—Na₂O—CaO, SiO₂—B₂O₃—BaO—ZnO, SiO₂—B₂O₃—Al₂O₃, SiO₂—B₂O₃—ZnO—Al₂O₃-K₂O, SiO₂—B₂O₃—ZnO—Li₂O, SiO₂—B₂O₃—ZnO—K₂O, PbO—B₂O₃—SiO₂, PbO—B₂O₃—SiO₂—ZnO, Bi₂O₃—H₃BO₃—ZnO, Sb₂O₃—PbO—B₂O₃, Bi₂O₃—B₂O₃—ZnO—Sb₂O₅, Sb₂O₃—B₂O₃—ZnO—K₂O, ZnO—B₂O₃—BaO—Al₂O₃, P₂O₅—ZnO—Na₂—O—Li₂O—BaO, P₂O₅—ZnO—Bi₂O₃, P₂O₅—ZnO—BaO—Na₂O, TeO₂—ZnO, TeO₂—Na₂O—ZnO—B₂O₃, TeO₂—ZnO—Na₂O—Al₂O₃, TeO₂—B₂O₃—ZnO—Na₂O—Al₂O₃, TeO₂—B₂O₃—Sb₂O₃—ZnO—Na₂O, TeO₂—Sb₂O₃—Li₂O—ZnO, and SnO—SnF₂—P₂O₅. These and other particular oxides and mixed oxides, are of interest in that they may be in the form of transparent, low melting point glass materials. Representative types of glass, as the first composition and preferably the second composition, may generally have a softening temperature of less than about 500° C., less than about 400° C., or less than about 350° C. Such glass compositions, when used as solid particles (e.g., powder particles) having the second composition, thereby have the capability of forming glass binder by heating to cause softening and/or melting, followed by cooling to consolidate the particles having the first composition. These particles may have a significantly higher melting temperature relative to the particles of the second composition, such that the particles of the first composition are not softened and/or melted by the heating.

In view of the above description of embodiments in which particles having the second composition may act, upon the application of sufficient heat, as a glass-forming binder, representative precursors may lack a binder-forming liquid or binder forming solid as described above. In this regard, embodiments of the invention are directed to precursors (e.g., in the form of a slurry) for forming radiative cooling compositions, with such precursors comprising (a) solid particles having a first composition as described above, and (b) solid particles having a second composition different from the first composition, with the second composition being a glass. Such precursors may optionally comprise a solvent as described herein (e.g., water, a hydrocarbon, or an oxygenated hydrocarbon). Particles having the first composition may have an average particle size representative of “nanoparticles or microparticles” as described above (with any of the specific, stated particle size ranges, such as a range from about 0.1 μm to about 5 μm), and/or solid particles having the second composition may, in preferred embodiments, have an average particle size characterized by “other average particles sizes, including larger average particle sizes,” as described above (with any of the specific, stated particle size ranges, such as a range from about 2 μm to about 20 μm).

In the particular case of precursors having solid particles of a composition (e.g., second composition) that is a glass, and more particularly a glass having a softening temperature as described above, in representative methods for forming a coating composition on a substrate using these precursors, a step (b) may comprise heating the precursor to a temperature that is at or above the softening temperature of the glass. This step may therefore include the use of higher temperatures (e.g., greater than 150° C., such as in the range from about 200° C. to about 700° C. or from about 400° C. to about 650° C.), beyond those for mere evaporation of solvent to effect drying of the applied precursor. Even in the case of using such higher temperatures to cause softening or melting of glass particles, this may be preceded by drying the applied precursor, or allowing it to dry. Whether or not a given precursor includes solid particles of a composition that is a glass, step (b) may comprise drying the applied precursor, or allowing it to dry, without the exposure to temperatures (e.g., greater than 150° C.) necessary for softening/melting of glass particles.

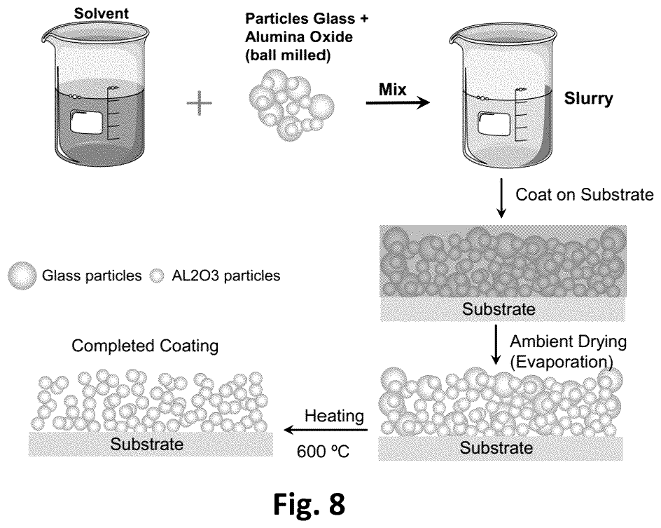

Therefore, according to more particular embodiments according to which precursors have solid particles of a composition (e.g., second composition) that is a glass, for example a glass having a softening temperature as described above, in representative methods for forming a coating composition on a substrate using these precursors, a step (b) may comprise both (b1) drying the precursor, or allowing the precursor to dry, in either case resulting in evaporation of the solvent, as described above, followed by (b2) heating the precursor to a temperature that is at or above the softening temperature of the glass. These particular embodiments are more specifically directed to precursors comprising (a) solid particles having a first composition comprising an inorganic oxide, nitride, carbide, sulfate, or carbonate, (b) solid particles having a second composition that is a glass, and (c) a solvent. For example, FIG. 8 illustrates a representative method for forming a coating composition on a substrate, utilizing a precursor comprising this combination of (a), (b), and (c) and prepared by combining the solvent with the two types of solid particles (e.g., alumina and glass), optionally following mixing of the combination or only the solid particles themselves. The precursor, in this case a slurry due to the presence of a solvent (e.g., water or an alcohol), is applied to (e.g., coated onto) the substrate, after which the precursor is (b1) dried or allowed to dry (e.g., under ambient conditions), causing evaporation of the solvent, and (b2) heated to a temperature (e.g., about 600° C.) that is at or above the softening temperature of the glass particles, causing these particles to sinter and form a binder (matrix or framework) for the solid particles having the first composition (e.g., alumina).

In a step (b) of drying an applied precursor, or allowing it to dry, according to methods for forming a coating composition on a substrate using precursors generally as described herein, such step, or possibly a sub-step, such as step (b1) as described above, is performed to cause evaporation of the solvent. Solvent removal by evaporation may be performed at ambient temperature (e.g., from about 15° C. to about 25° C.), or may be facilitated by exposure of the precursor to elevated temperature (e.g., greater than about 25° C., such as from about 50° C. to about 150° C.). Elevated temperatures, for example achieved using a suitable heater (e.g., hot air gun or oven), reduce drying times needed for evaporation of solvent and formation of the coating composition, with all other variables being equal. In general, depending on the specific precursor, including its solvent content, as well as ambient humidity, representative drying times are generally in the range from about 30 minutes to about 24 hours, such as from about 1 hour to about 8 hours.

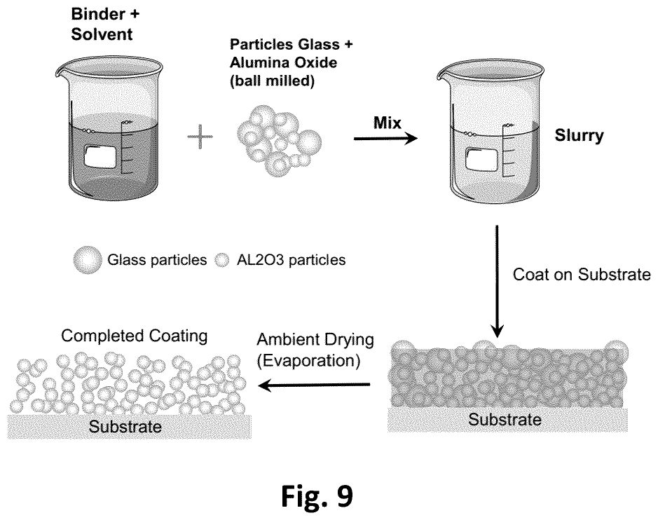

Regardless of the specific type of precursor, and as illustrated in both FIGS. 8 and 9, the step (b) may be preceded by a step (a) of applying the precursor to the substrate, optionally following combining the precursor with a solvent (e.g., water or an alcohol) and/or optionally with the precursor having been subjected to mixing or more generally any type of mechanical agitation/energy input to cause blending of the precursor components. Some embodiments, for example, are more specifically directed to precursors comprising (a) solid particles having a first composition comprising an inorganic oxide, nitride, carbide, sulfate, or carbonate, (b) a binder-forming liquid or a binder-forming solid. In this regard, FIG. 9 illustrates a representative method for forming a coating composition on a substrate, utilizing a precursor comprising this combination of (a) and (b), in which component (b) is more specifically a binder-forming liquid such as water glass, which refers to a sodium silicate binder-forming liquid having water as a solvent. As shown in FIG. 9, a binder-forming liquid may be more generally characterized as a solution of a binder-forming solid (binder) and a solvent. The coating composition is prepared by combining the binder-forming liquid with at least one, and possibly two, types of solid particles (e.g., alumina alone or and alumina and glass), optionally following mixing of the combination or only the one or two types of solid particles themselves. The precursor, in this case a slurry due to the presence of a binder-forming liquid and its solvent, is applied to (e.g., coated onto) the substrate, after which the precursor is dried or allowed to dry (e.g., under ambient conditions), causing evaporation of the solvent. In this case, temperatures in excess of those needed for effective drying of the precursor (e.g., temperatures in excess of 50° C., 100° C., or 150° C.), may not be necessary to form the coating composition, having a binder (matrix or framework) for the solid particles (e.g., alumina or other solid particles having the first composition), which is formed from evaporation of solvent from the binder-forming liquid.

Whether or not a precursor comprises solid particles having a composition that is a glass, and more particularly a glass characterized by having a softening temperature as described above, such precursor may nonetheless further comprise a binder-forming liquid or binder-forming solid as described herein, and a step (b) of drying the precursor, or allowing the precursor to dry, may nonetheless be used in a method for forming a coating composition, using such precursor. The binder-forming liquid or binder-forming solid may be present in such precursor, on a solvent-free basis, in an amount corresponding to the weight percentage ranges given above (e.g., from about 10 wt-% to about 60 wt-%). Particular embodiments of the invention extend to any precursors described herein, which, prior to step (b) have been subjected to processing steps to improve homogeneity, adjust particle size (e.g., reduce particle size and/or narrow the particle size distribution), and/or otherwise refine the precursor. In this regard, representative precursors include refined precursors having been subjected to milling, sonication, fines removal (e.g., by filtration), or other treatments to improve their characteristics for forming coating compositions.

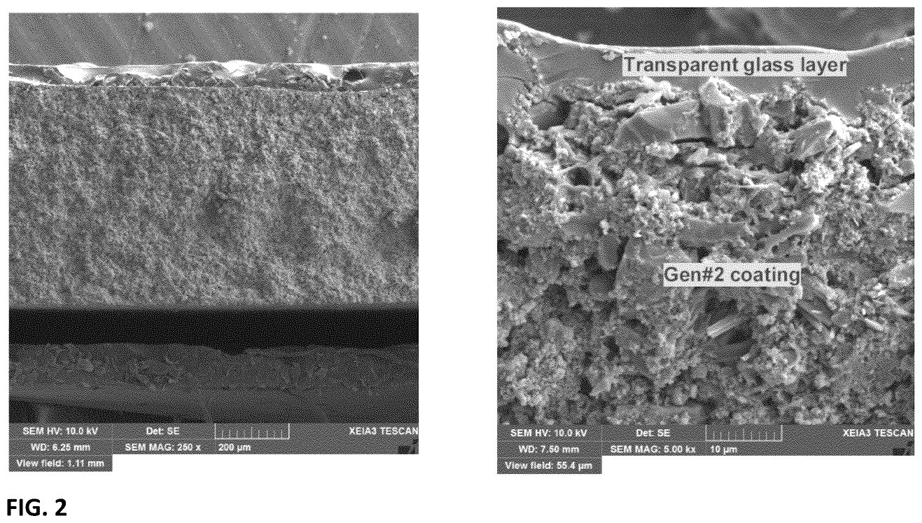

In some cases, methods may further comprise (e.g., following step (b)), applying a protective layer on the coating composition (e.g., a dense, clear protective layer), to form an overlaid coating composition. The protective layer may, for example, be formed from a binder-forming liquid (e.g., the same binder-forming liquid used as a component of the precursor) as described herein, but without solid particles, or at least having a reduced content of solid particles, relative to the content in the underlying coating composition. In this regard, FIG. 2 provides SEM images of a radiative cooling composition of a dual-particle design as described with respect to FIG. 1, but also being overlaid with a dense, clear protective overlayer (e.g., as a glass), formed of the binder without solid particles. In particular embodiments, therefore, representative methods may comprise applying a silicate protective layer (e.g., water glass or other silicate solution that dries to form a transparent glass layer) on the coating composition, to form a glass-overlaid composition. Optionally, the protective layer may include a pigment as described herein, and, also optionally, such pigment may be absent from the underlying coating composition, or otherwise may be present in the underlying coating composition in a reduced amount, relative to the amount at which such pigment is present in the protective layer. Preferably, the underlying coating composition has a porosity of at least about 10% (e.g., from about 10% to about 30%), as described above with respect to coating compositions generally. Whether or not overlaid, representative coating compositions (or underlying coating compositions) may have a thickness generally from about 50 μm to about 5 mm, typically from about 100 μm to about 2 mm, and often from about 200 μm to about 1 mm. In the particular case of overlaid compositions (e.g., glass-overlaid compositions), to which further embodiments of the invention are directed, the protective layer (e.g., glass layer) may have a thickness generally from about 1 μm to about 500 μm, typically from about 10 μm to about 300 μm, and often from about 25 μm to about 250 μm.

Representative substrates, to which precursors may be applied, and on which coating compositions or overlaid coating compositions may be formed, include brick, tile, metal (e.g., steel or aluminum), wood, asphalt, concrete, plastic, glass, and ceramic. Such substrates are representative of materials and their surfaces, which may benefit from the application of a coating to provide radiative cooling, as described herein. These materials and surfaces correspond to those employed in buildings, road construction, processing facilities, vehicles including spacecraft, and a number of other applications that would be recognized by those having skill in the art, with the knowledge gained from the present disclosure. In some cases, it may be advantageous to utilize a primer to condition the surface of a given substrate for improved application (e.g., adherence) of a given precursor. Accordingly, steps described herein of applying a precursor to a substrate do not preclude application to a substrate surface on which a primer has been applied.

Particular embodiments of the invention include, but are not limited to:

1. A precursor for forming a radiative cooling composition, the precursor comprising:
(a) solid particles having at least a first composition comprising an inorganic oxide, nitride, carbide, sulfate, or carbonate, and
(b) an inorganic binder-forming liquid or an inorganic binder-forming solid,
wherein when the precursor is applied, optionally following the addition of a solvent in the case of an inorganic binder-forming solid, and subjected to drying to remove all or substantially all of said solvent of the precursor and to form a coating composition having a thickness of 500 μm, said coating has a solar reflectance of at least about 0.80 and a infrared emissivity at least about 0.80 in a wavelength range from 8 μm to 13 μm.

2. The precursor of embodiment 1, wherein the inorganic binder-forming liquid or inorganic binder-forming solid is a silicate binder-forming liquid or silicate binder-forming solid.

3. The precursor of embodiment 1 or embodiment 2, wherein the inorganic binder-forming liquid or inorganic binder-forming solid is present in the precursor, on a solvent-free basis, in an amount from about 10 wt-% to about 60 wt-%.

4. The precursor of any one of embodiments 1 to 3, wherein the solid particles having the first composition comprise an inorganic oxide.

5. The precursor of embodiment 4, wherein the inorganic oxide is selected from the group consisting of Al₂O₃, SiO₂, ZnO, TiO₂, and MgO.

6. The precursor of any one of embodiments 1 to 5, wherein the solid particles having the first composition have an average particle size from about 0.1 μm to about 20 μm.

7. The precursor of embodiment 2, wherein the silicate binder-forming liquid comprises an alkali metal silicate solution or alkaline earth metal silicate solution, and wherein the precursor is a slurry.

8. The precursor of embodiment 7, wherein the slurry has a total solids content of at least about 5 wt-%.

9. The precursor of any one of embodiments 1 to 8, wherein the silicate binder-forming solid is sodium silicate.

10. The precursor of any one of embodiments 1 to 9, wherein component (b) is a silicate binder-forming solid, and wherein the composition further comprises a solvent.

11. The precursor of embodiment 10, wherein the solvent comprises water, a hydrocarbon, or an oxygenated hydrocarbon.

12. The precursor of any one of embodiments 1 to 11, further comprising solid particles having a second composition different from the first composition.

13. The precursor of embodiment 12, wherein the solid particles having the first composition and the solid particles having the second composition are present in the precursor in a first composition:second composition weight ratio from about 100:1 to about 1:100.

14. The precursor of embodiment 12 or embodiment 13, wherein the solid particles having the second composition have an average particle size from about 0.5 μm to about 20 μm.

15. The precursor of any one of embodiments 12 to 14, wherein the second composition is a glass.

16. The precursor of embodiment 15, wherein the glass has a softening temperature of less than about 500° C.

17. A precursor for forming a radiative cooling composition, the precursor comprising:
(a) solid particles having a first composition comprising an inorganic oxide, nitride, carbide, sulfate, or carbonate, and
(b) solid particles having a second composition different from the first composition, wherein the second composition is a glass, and
(c) optionally a solvent comprising water, a hydrocarbon, or an oxygenated hydrocarbon,
   wherein the solid particles having the first composition are particles having an average particle size from about 0.1 μm to about 20 μm, and wherein the solid particles having the second composition have an average particle size from about 0.5 μm to about 20 μm.

18. The precursor of embodiment 17, further comprising a binder-forming liquid or a binder-forming solid.

19. The precursor of embodiment 18, wherein the binder-forming liquid or binder-forming solid is present in the precursor, on a solvent-free basis, in an amount from about 10 wt-% to about 60 wt-%.

20. The precursor of any one of embodiments 1 to 19, further comprising a pigment, quantum dots, or semiconductors.

21. The precursor of embodiment 20, wherein the pigment, quantum dots, or semiconductors are present in the precursor in an amount from about 1 wt-% to about 10 wt-%.

22. The precursor of any one of embodiments 1 to 21, wherein an organic polymer is absent from the precursor.

23. A refined precursor, comprising the precursor of any one of embodiments 1 to 22, having been subjected to mixing.

24. A method for forming a coating composition on a substrate, the method comprising:
(a) applying the precursor of any one of embodiments 1 to 23 to the substrate, optionally following combining the precursor with a solvent and/or optionally wherein the precursor has been subjected to mixing, and
(b) drying the precursor, or allowing the precursor to dry,
to form the coating composition.

25. The method of embodiment 24, wherein step (a) is performed by spraying or brushing the precursor, optionally following combining the precursor with a solvent and/or optionally wherein the precursor has been subjected to mixing, onto the substrate.

26. The method of embodiment 24 or embodiment 25, wherein step (b) is performed at ambient temperature or elevated temperature.

27. A method for forming a coating composition on a substrate, the method comprising:
(a) applying the precursor of embodiment 17 to the substrate, optionally following combining the precursor with a solvent and/or optionally wherein the precursor has been subjected to mixing, and
(b) heating the precursor to a temperature that is at or above a softening temperature of the second composition.

28. The method of any one of embodiments 24 to 27, wherein the substrate is selected from the group consisting of brick, tile, metal, wood, plastic, glass, and ceramic.

29. The method of any one of embodiments 24 to 28, further comprising applying a protective layer on the coating composition, to form a glass-overlaid coating composition.

30. A coating composition formed by the method of any one of embodiments 24 to 28, or a glass-overlaid coating composition formed by the method of embodiment 29.

31. The coating composition or the glass-overlaid coating composition of embodiment 30, wherein the coating composition has a porosity of at least 10%.

32. The coating composition or the glass-overlaid coating composition of embodiment 31, wherein the coating composition has a thickness from about 50 μm to about 5 mm.

33. The glass-overlaid composition of embodiment 31 or embodiment 32, comprising the coating composition that is overlaid with a glass layer, wherein the glass layer has a thickness from about 1 μm to about 500 μm.

34. The coating composition or the glass-overlaid coating composition of any one of embodiments 30 to 33, having a solar reflectance of at least 0.80 and/or a infrared emissivity of at least 0.80 in a wavelength range from 8 μm to 13 μm.

Overall, aspects of the invention relate to radiative cooling compositions, such as in the form of coatings, or overlaid coatings, on substrates, exhibiting advantageous properties in terms of their ability to reflect solar radiation and emit heat through the atmospheric transparency window. Through manipulation of the types of relative amounts of precursor components, these compositions can be engineered to achieve a desirable combination of performance characteristics and mechanical strength, thereby addressing drawbacks encountered in providing radiative cooling with other material types and corresponding fabrication methods. Those having skill in the art, with the knowledge gained from the present disclosure, will recognize that various changes can be made to precursors, coating compositions, and methods for their production, in attaining these and other advantages, without departing from the scope of the present disclosure. The specific embodiments illustrated and described herein are for illustrative purposes only, and not limiting of the invention as set forth in the appended claims.

The following examples are set forth as representative of the present invention. These examples are not to be construed as limiting the scope of the invention as other equivalent embodiments will be apparent in view of the present disclosure and appended claims.

### EXAMPLE 1

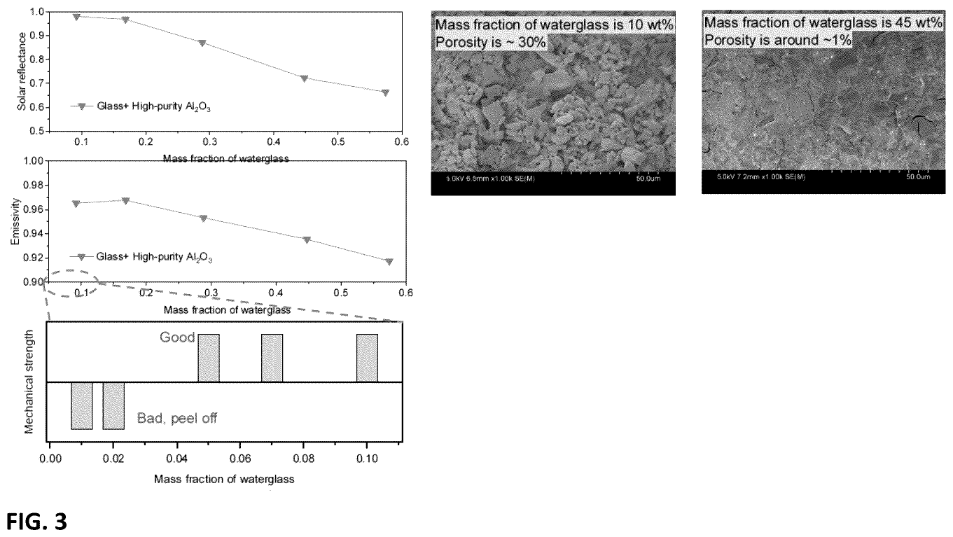

Coating compositions comprising Al₂O₃ nanoparticles (0.5 μm average diameter) and glass particles (7 μm average diameter) were prepared, using the method illustrated in FIG. 8, from precursors having varying amounts water glass as a sodium silicate binder-forming solution, to yield correspondingly varying mass fractions of binder in the compositions. The performance properties of solar reflectance and emissivity were determined as a function of these mass fractions, in addition to mechanical strength properties of the compositions. FIG. 3 provides SEM images of the compositions, as well as graphs summarizing the experimental results. Based on these tests, as the binder content increased from 10% to about 60%, solar reflectance decreased from 0.97 to 0.7, while infrared emissivity decreased from 0.98 to 0.92. Also within this range of binder mass fractions, the porosity of the coating compositions decreased from about 30% to about 1%. For this coating composition, it was determined that, at a binder content of less than about 30 wt-%, corresponding to a porosity range of 0-30%, a solar reflectance above 0.8 and an infrared emissivity above 0.9 could be achieved.

### EXAMPLE 2

Coating compositions, their performance properties, and their mechanical strength, were

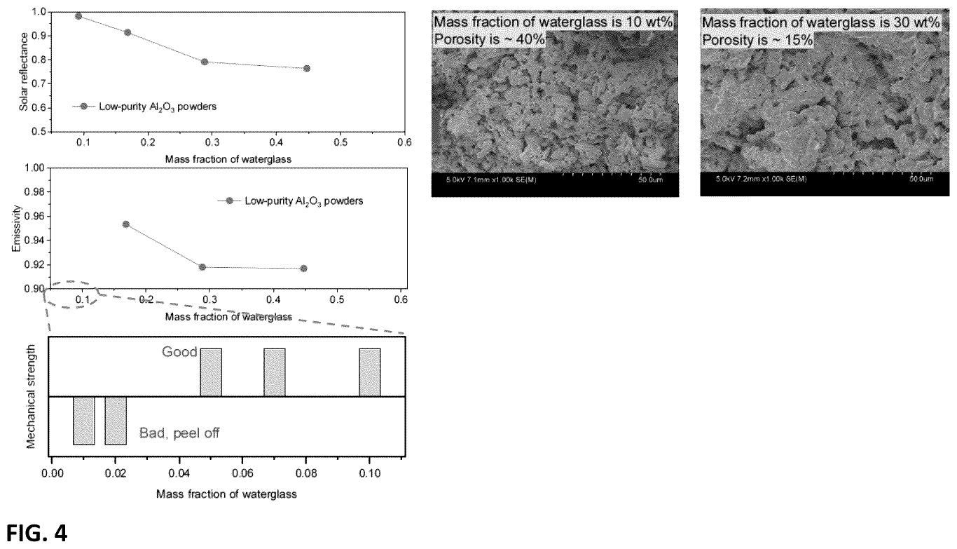

determined and evaluated as described with respect to Example 1. However, these coating compositions contained only a single type of solid particle, namely Al₂O₃ microparticles (4 μm average diameter). FIG. 4 provides SEM images of the compositions, as well as graphs summarizing the experimental results. Based on these tests, as the binder content increased from 10% to about 45%, solar reflectance decreased from 0.97 to 0.76, while infrared emissivity decreased from greater than 0.95 to 0.91. Also within this range of binder mass fractions, the porosity of the coating compositions decreased from about 40% to 15%. For this coating composition, it was determined that, at a binder content of less than about 30 wt-%, corresponding to a porosity range of 15-40%, a solar reflectance above 0.8 and an infrared emissivity above 0.9 could be achieved.

### EXAMPLE 3

Coating compositions, their performance properties, and their mechanical strength, were

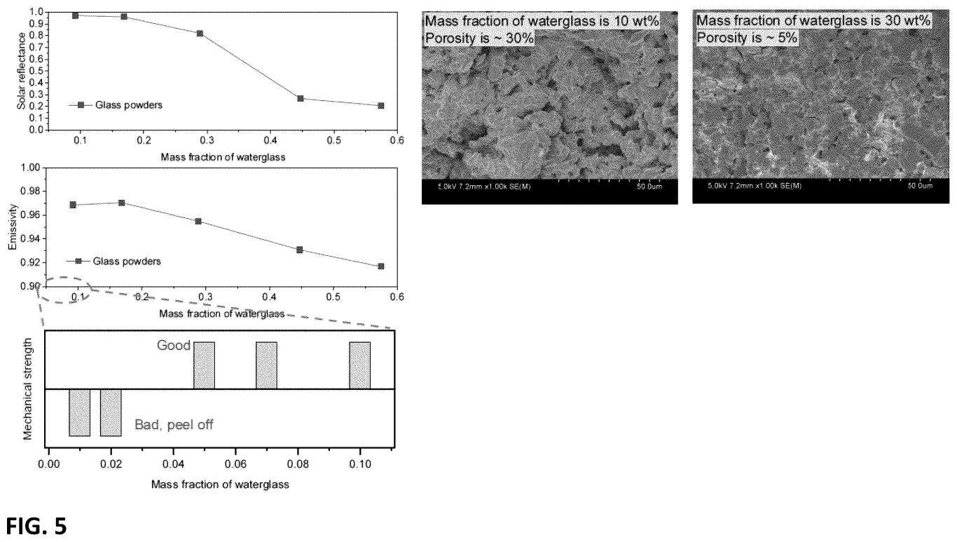

determined and evaluated as described with respect to Example 1. However, these coating compositions contained only a single type of solid particle, namely glass microparticles (7 μm average diameter). FIG. 5 provides SEM images of the compositions, as well as graphs summarizing the experimental results. Based on these tests, as the binder content increased from 10% to about 60%, solar reflectance decreased from 0.97 to 0.2, while infrared emissivity decreased from 0.97 to 0.91. Also within this range of binder mass fractions, the porosity of the coating compositions decreased from about 30% to 5%. For this coating composition, it was determined that, at a binder content of less than about 30 wt-%, corresponding to a porosity range of 5-30%, a solar reflectance above 0.8 and an infrared emissivity above 0.9 could be achieved.

### EXAMPLE 4

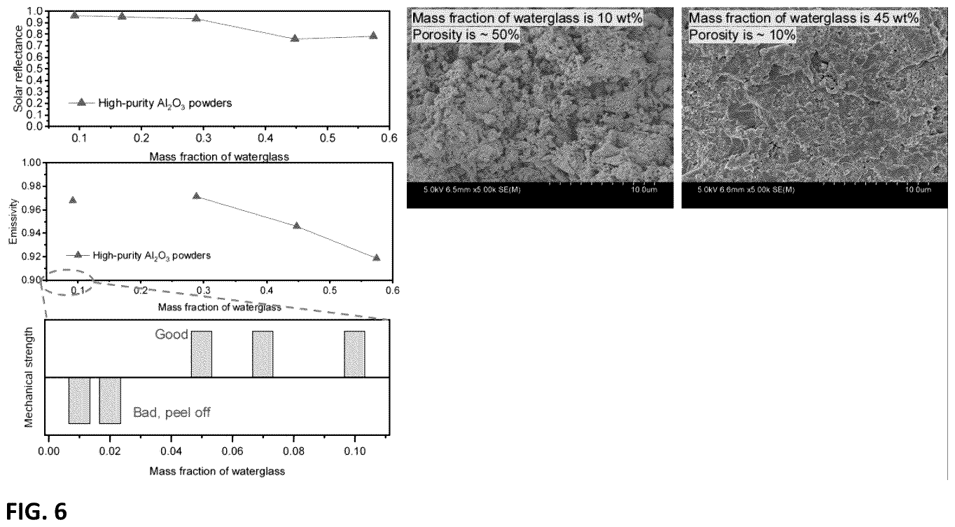

Coating compositions, their performance properties, and their mechanical strength, were determined and evaluated as described with respect to Example 1. However, these coating compositions contained only a single type of solid particle, namely Al₂O₃ nanoparticles (0.5 μm average diameter). FIG. 6 provides SEM images of the compositions, as well as graphs summarizing the experimental results. Based on these tests, as the binder content increased from 10% to about 60%, solar reflectance decreased from 0.98 to 0.8, while infrared emissivity decreased from 0.97 to 0.92. Also within this range of binder mass fractions, the porosity of the coating compositions decreased from about 50% to 10%. For this coating composition, it was determined that, at a binder content of less than about 30 wt-%, corresponding to a porosity range of 10-50%, a solar reflectance above 0.8 and an infrared emissivity above 0.9 could be achieved.

### EXAMPLE 5

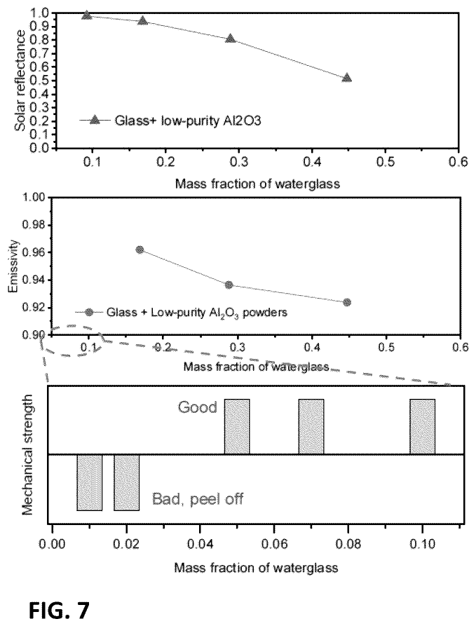

Coating compositions, their performance properties, and their mechanical strength, were determined and evaluated as described with respect to Example 1. However, these coating compositions contained both Al₂O₃ microparticles (4 μm average diameter) and glass microparticles (7 μm average diameter). FIG. 7 provides graphs summarizing the experimental results. Based on these tests, as the binder content increased from 10% to about 45%, solar reflectance decreased from 0.98 to 0.5, while infrared emissivity decreased from 0.96 to 0.92.

### EXAMPLE 6

An SEM image was taken and the microporous coating was analyzed, after sintering at about

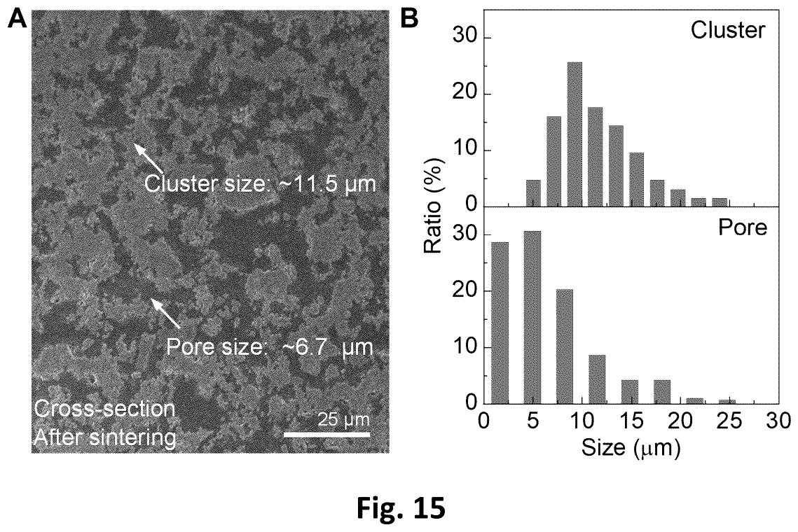

600° C., of a typical composition manufactured according to the method illustrated in FIG. 8. Results are illustrated in FIG. 15. In particular, part (A) of FIG. 15 provides an SEM image of a cross-sectional morphology of a representative microporous coating filled with polymeric resin (darker gray color). To infiltrate the porous radiative cooling glass with epoxy resin, the components of this resin were mixed and applied to the glass in a mold, followed by a degassing process and atmospheric pressure filling, repeated three times. The mold was then maintained static at 30° C. for 12 hours to ensure complete resin infiltration. Part (B) of FIG. 15 shows the size distribution of the glass-Al₂O₃ clusters and pores after sintering. Approximately 60% of these clusters were in the 8-13 μm range, while about 80% of the pores were smaller than 10 μm. The particle/pore size distributions were derived from SEM images using ImageJ software, with particle sizes determined by the maximum Feret diameter. To ensure representative results, over 30 particles from various regions within the SEM images were analyzed.

### EXAMPLE 7

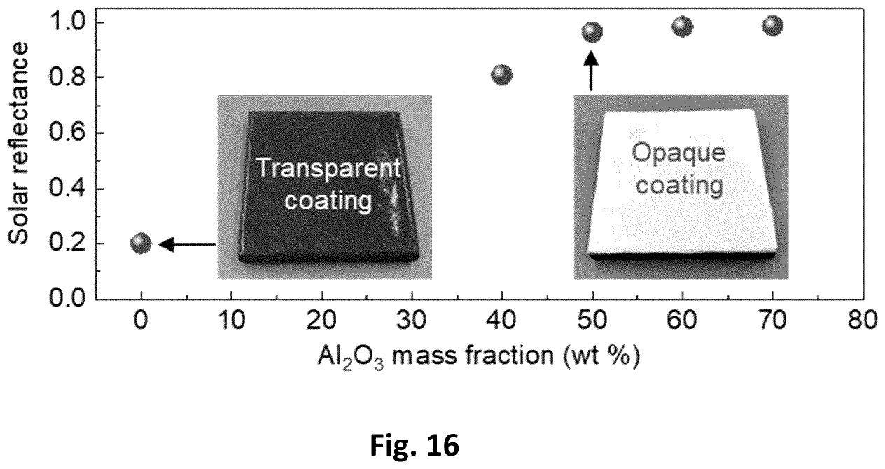

For a particular coating composition, the effect of the Al₂O₃ particle mass fraction on the solar reflectance of this radiative cooling glass, having with a thickness of about 550 μm was determined. Results are illustrated in FIG. 16. Without Al₂O₃ particles, the glass particles merge during the heat treatment, eliminating most of the pores and forming a transparent coating with a very low solar reflectance of above 0.2. With the addition of Al₂O₃ particles (e.g., 40 wt-%), the coating becomes slightly porous, and its solar reflectance improves remarkably (to about 0.8). When the mass fraction of the Al₂O₃ particles increases to 50 wt-%, the resulting coating (thickness of about 550 μm) forms a porous structure (50% porosity) and demonstrates a high solar reflectance of about 0.96 due to the Al₂O₃ preventing the glass particles from completely merging. When the mass fraction of the Al₂O₃ was increased to greater than 60 wt-%, the solar reflectance of the coating increased to 0.98.

### EXAMPLE 8

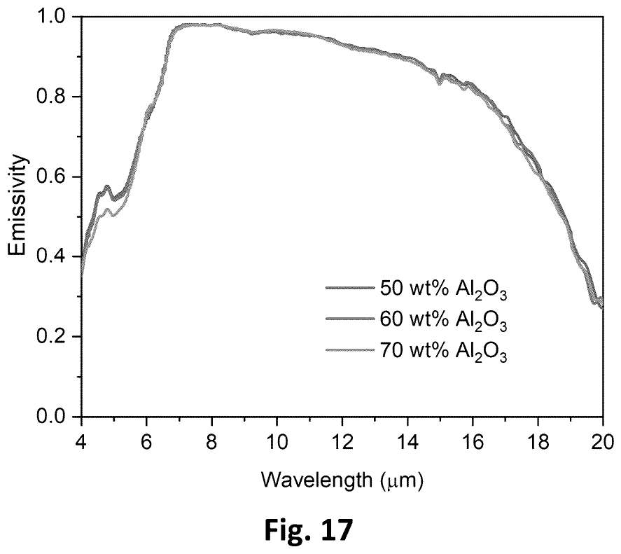

A less pronounced effect, for a particular coating composition, of the mass fraction of Al₂O₃ particles on the infrared emissivity of the radiative cooling glass coating with a thickness of about 550 μm, was measured. Results are illustrated in FIG. 17. Between 50 and 70 wt-%, the radiative cooling glass coating exhibited a selective high emissivity (about 0.95) in the atmospheric transparency window (8 to 13 μm).

### EXAMPLE 9

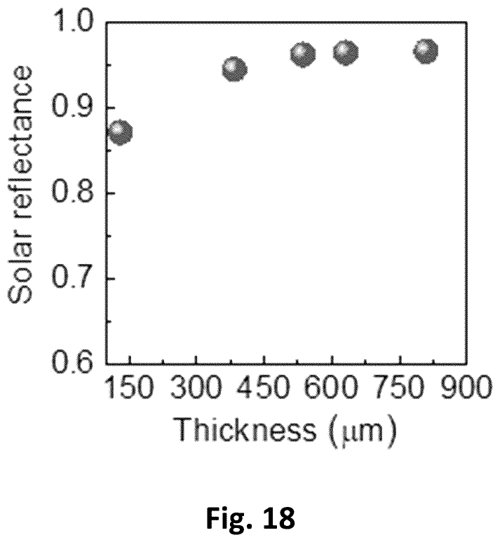

The effect of the thickness of a radiative cooling glass coating on its solar reflectance, with respect to a particular composition in which the mass fraction of the Al₂O₃ particles was about 50 wt-%, was determined. Results are illustrated in FIG. 18. Solar reflectance was observed to be about 0.78 at a thickness of about 150 μm, increasing to 0.961 at about 540 μm thickness.

### EXAMPLE 10

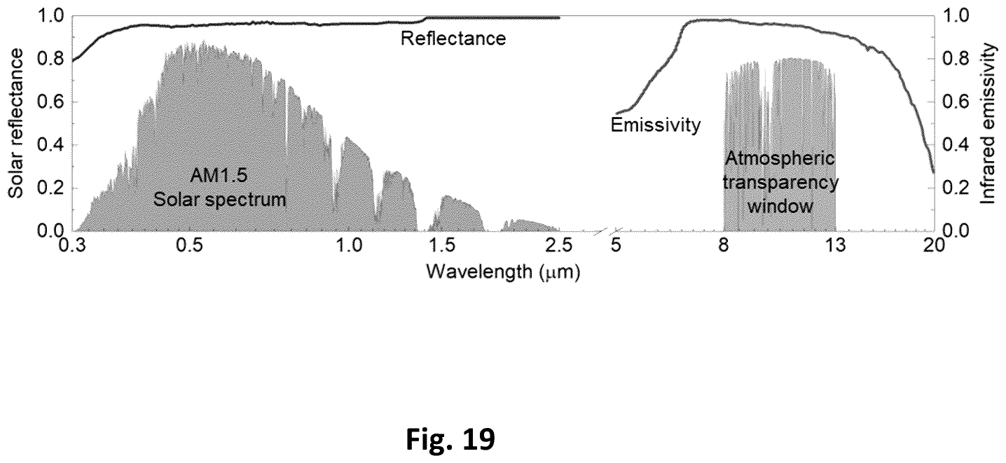

A spectrum of a radiative cooling composition, used as a coating, was determined. Results are illustrated in FIG. 19. More particularly, the measured solar reflectance and infrared emissivity of this coating with a thickness of about 550 μm are shown in the range of 0.3-20 μm. The radiative cooling glass coating exhibited a high solar reflectance of 0.96 and selective high emissivity in the atmospheric transparency window (8-13 μm), while simultaneously radiating heat to the cold sink of outer space in the form of LWIR infrared radiation.

### EXAMPLES 11 AND 12

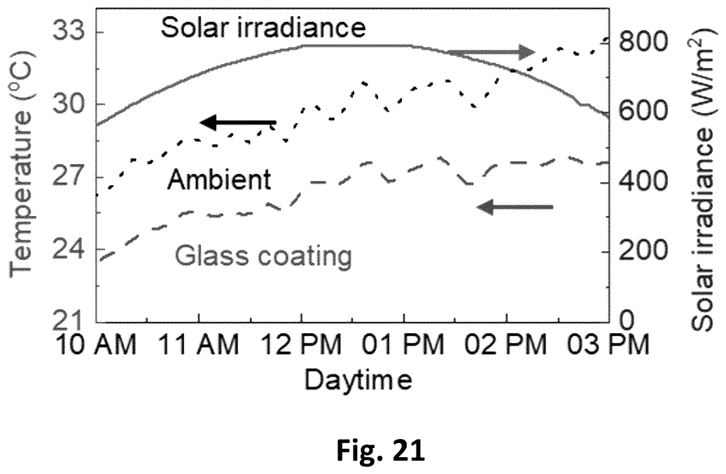

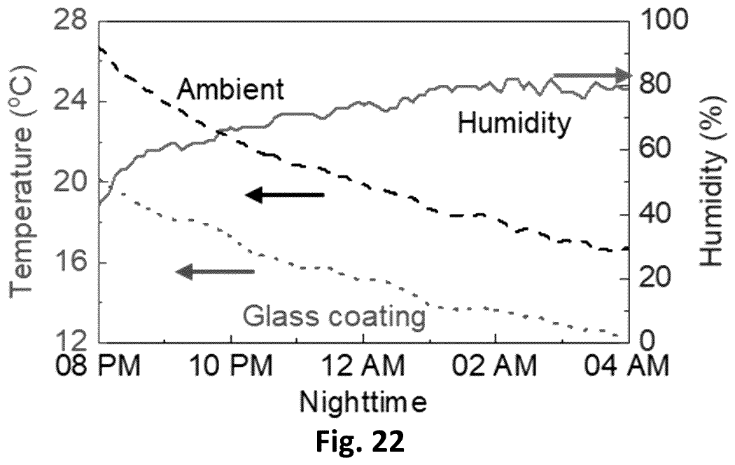

Cooling performance was measured for a radiative cooling composition in daytime, and results are illustrated in FIG. 21. More particularly, the temperature of a ceramic tile substrate coated with a radiative cooling glass coating (about 550 μm thick, 50 wt-% Al₂O₃ and 50 wt-% glass binder) was measured under direct sunlight. The outdoor thermal performance was measured in College Park, MD, USA [38.9897° N, 76.9378° W, 22 m altitude] from 10 AM on Jun. 6, 2022, to 4 AM on Jun. 7, 2022. At midday (12-1 PM), the temperature of the glass coating (long dashed line) was 3.5° C. lower than the ambient temperature (short dashed line) of 30° C. at 30% relative humidity, about 1.5 m/s wind speed, and a solar irradiance (solid line) of about 790 W/m². The cooling power of the glass coating was estimated to be approximately 60 W/m². Using the same sample, cooling performance at nighttime was also measured. During the night (2-4 AM), the glass coating (short dashed line) was about 4° C. cooler than the surrounding temperature (long dashed line) of 17.5° C. at a high humidity (solid line) of up to 80% and a wind speed of 0.7 m/s. The cooling power of the glass coating is estimated to be about 60 W/m². Results are illustrated in FIG. 22.

### EXAMPLE 13

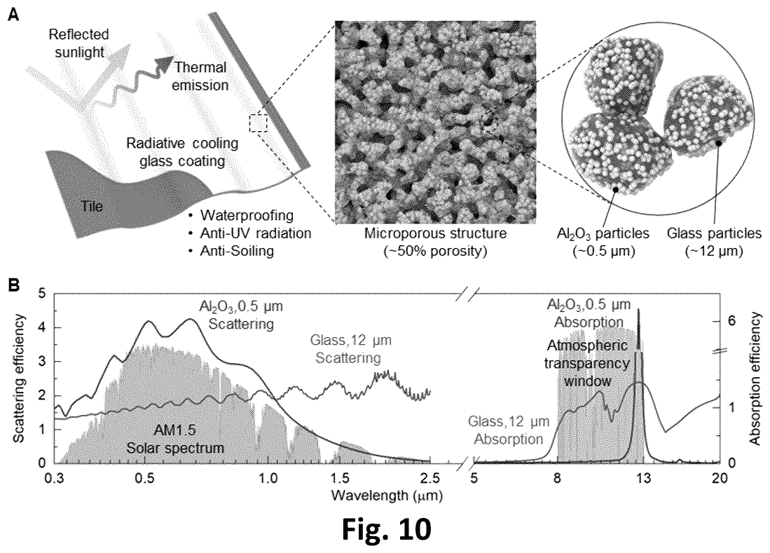

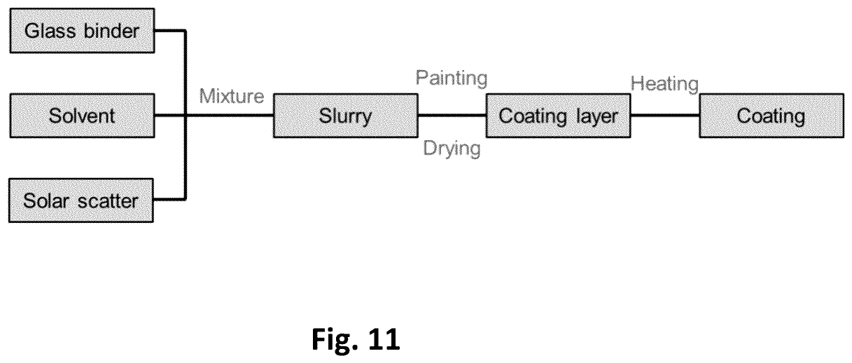

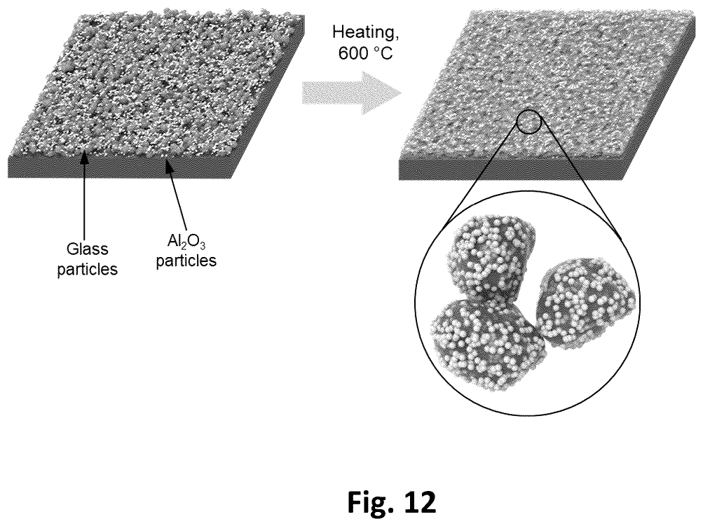

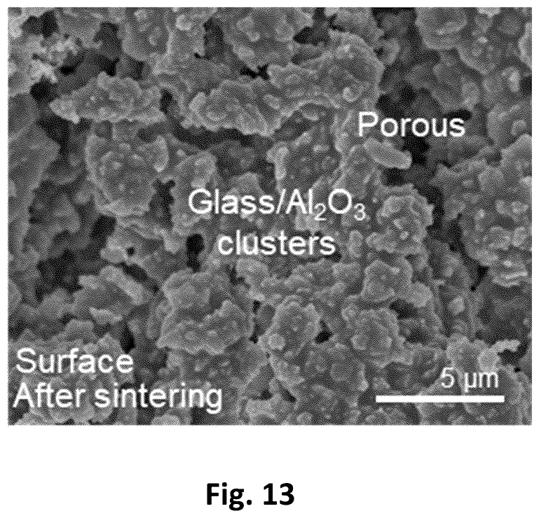

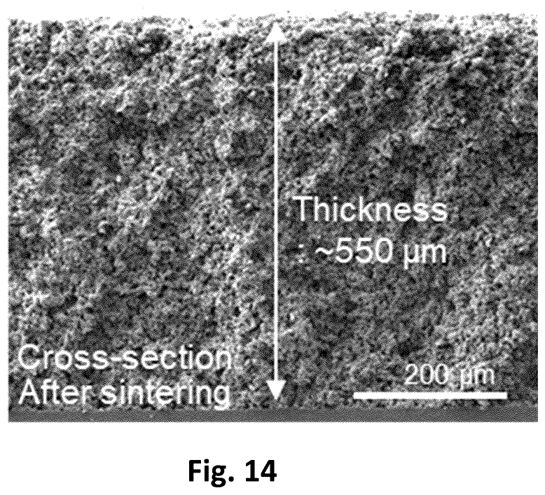

A sample composition was manufactured using the method illustrated in FIG. 9 and FIG. 11. According to a typical process, precursor powders (Al₂O₃ nanoparticles, 500 nm diameter) were combined with commercial low-melting point glass powders (9 μm diameter) in a 1:1 mass ratio. This mixture was ball milled for 2 hours at a speed of 300 rpm, then dispersed in ethanol (1 ml/g) using sonication to produce the precursor slurry. This slurry exhibited favorable fluidity and wettability on various substrates, including glass, metal foil, and ceramics, making it suitable for multifunctional device applications. Moreover, the concentration and viscosity of the precursor slurry could be adjusted to suit different printing and other application techniques, such as spray coating and brush coating methods. This composition exhibited properties illustrated in FIG. 10, which shows (A) a schematic of the radiative cooling glass coating on a ceramic roofing tile, which can effectively reflect solar radiation (0.3-2.5 μm) and emit infrared radiation (i.e., thermal emission) to the cold sky through the atmospheric transparency window (8-13 μm). In this embodiment, the radiative cooling glass coating featured a porous structure (porosity 50%), in which low-melting-point glass particles (mean diameter about 6 μm, volume 30.4%) were partially sintered to form a framework decorated with Al₂O₃ particles (mean diameter of about 0.5 μm, volume 19.6%). The characteristic size of the glass clusters after sintering was about 12 μm. In (B), FIG. 10 also illustrates the optical functionality of the glass particles and Al₂O₃ particles in the composite structure. The scattering and absorption efficiencies as a function of wavelength for glass and Al₂O₃ particles were calculated based on Lorenz-Mie theory. The dual particle design maximized material and dimensional effects associated with passive radiative cooling, specifically high reflectance in the solar spectrum and high emissivity in the atmospheric transparency window. FIG. 12 shows that by heating to about 600° C., the low-melting-point glass microparticles in the mixture could be rapidly sintered to form an interconnected mesoporous structure. FIG. 13 shows an SEM image of the glass and Al₂O₃ particle mixture after sintering at about 600° C. for 1 minute. After the heat treatment, the Al₂O₃ particles were dispersed with the softened and merged glass particles, forming a cohesive microporous structure. FIG. 14 shows an SEM image of the cross-sectional morphology of the microporous coating after sintering at about 600° C. The example coating used for the image of FIG. 14 had a thickness of about 550 μm, and this image confirmed a porous structure.

### EXAMPLE 14

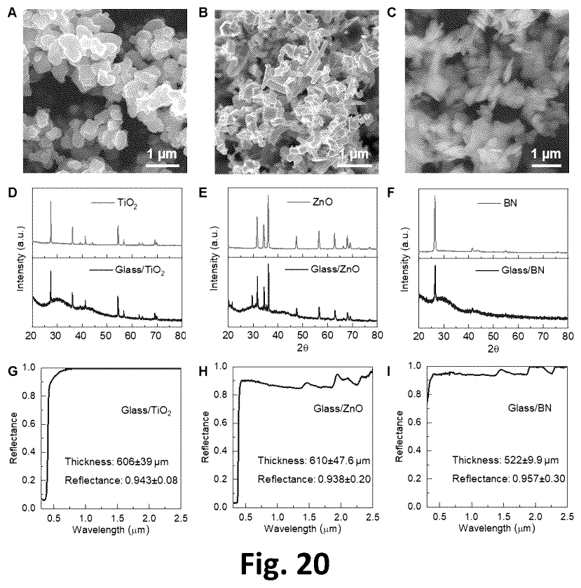

Process compatibility with a wide range of particles is illustrated in FIG. 20. More particularly, this figure shows SEM images of (A) TiO₂ particles, (B) ZnO particles, and (C) BN disks, with a mean diameter of about 0.5 μm. XRD patterns are also shown, of glass coatings sintered using (D) TiO₂, (E) ZnO, and (F) BN particles as sunlight scatterers. Further shown are graphs of solar reflectance versus wavelength of glass coatings employing (G) TiO₂, (H) ZnO, and (I) BN particles as sunlight scatterers. These analyses are indicative of a manufacturing process that is compatible with a wide range of dielectric particles, such as TiO₂, ZnO and BN and that produces coatings with strong reflectivity.

### EXAMPLE 15

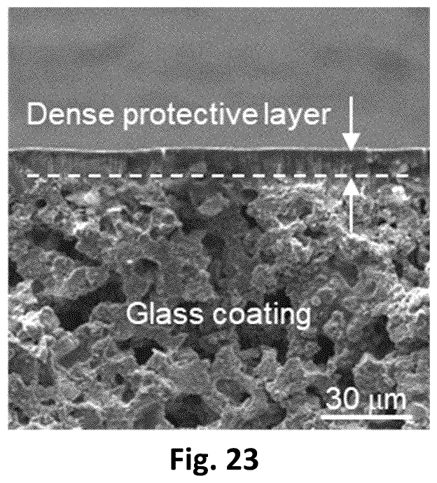

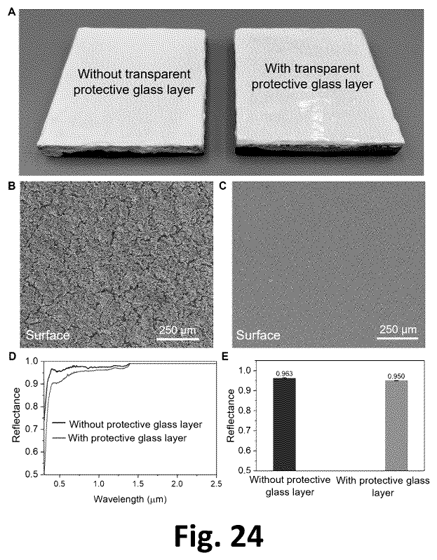

An SEM image was taken of the radiative cooling glass coating as described in Example 1, and covered by a dense and transparent protective layer of thin solid glass with a thickness of about 20 μm. This image is illustrated in FIG. 23, with annotations. The dense structure of the transparent protective layer allows liquid pollutant (high concentration carbon nanoparticles dispersed in water) to be easily cleaned from the cooling glass coating, providing excellent anti-contamination functionality. FIG. 24 provides a comparison of the radiative cooling glass coatings without, and with, a transparent protective glass layer. In (A), a comparison is provided between the appearance of the original radiative cooling glass coating (left) and the radiative cooling glass coating covered with the transparent protective glass layer (right). The left picture might be characterized as having a matte finish, whereas the right picture might be characterized as having a glossy finish, which would feel smoother to the touch. In (B) and (C), SEM images of the original radiative cooling glass coating and radiative cooling glass coating covered with the transparent protective glass layer are provided. In (D) and (E), comparisons of the solar reflectance spectra and averaged solar reflectance, respectively, of the radiative cooling glass coatings without, and with, the addition of the transparent protective glass layer are provided. By adding a transparent dense glass coating with a thickness of about 10 μm, the averaged solar reflectance of the radiative cooling glass coating is reduced by about 1.3%, though still achieving a desirable value of about 0.95.

### EXAMPLE 16

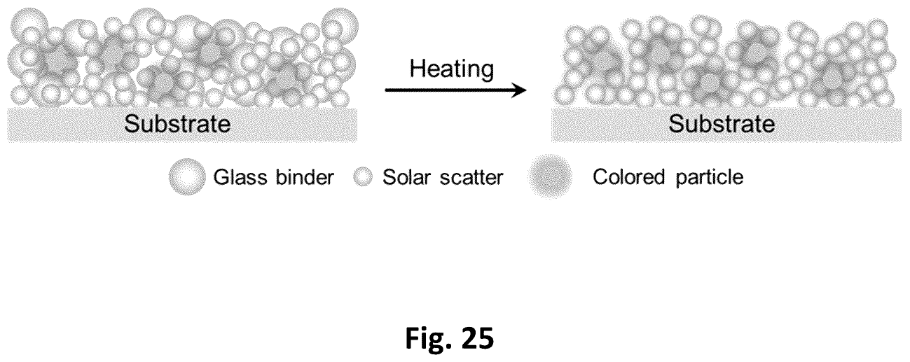

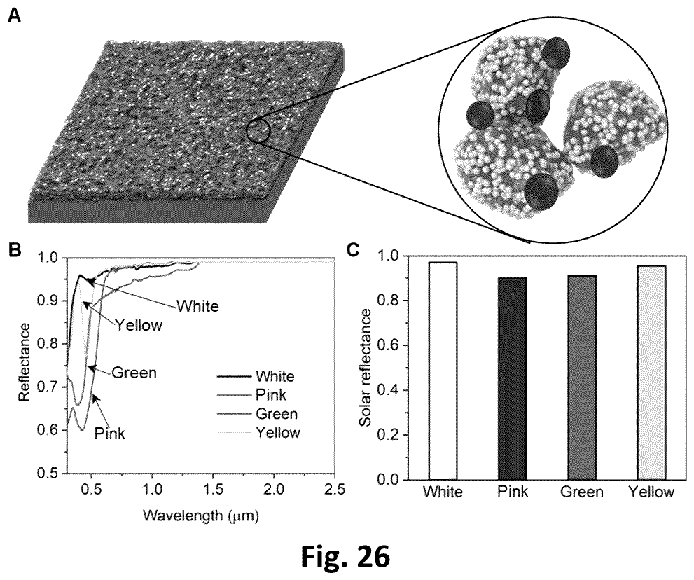

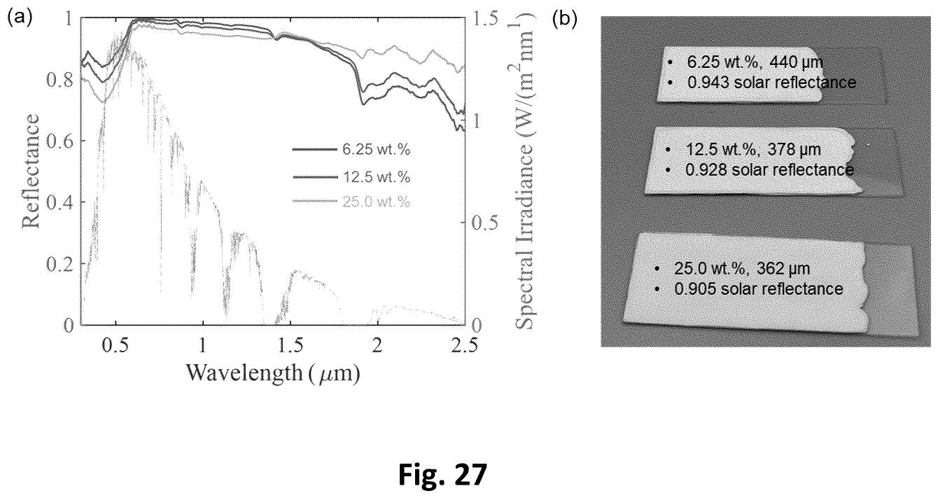

Colored sample coating compositions were prepared, including yellow, pink and green samples (samples without pigments are white), according to the method used in Example 1. The geometric structure of the colored glass-ceramic daytime radiative cooling coating is shown in FIG. 25. The colored appearance of the glass-ceramic coating can be obtained by mixing the precursors (e.g., in powder or slurry form) with colored pigments, such as, but not limited to, phosphors (e.g., Y₃Al₅O₁₂:Ce, Y₃(AlGa)₅O₁₂:Ce, SrSiO₄:Eu, and CaAlSiN₃:Eu), oxides (e.g., Fe₂O₃, WO₃), and quantum dots (e.g., CdSe, CdS, ZnS). In this construction, glass binder refers to glass particles that become binder when heated, and solar scatter refers to reflective particles such as Al₂O₃. Manufacturing and optical characterization of the colored radiative cooling structures, and illustrations of colored samples achieving very good solar reflectivity are provided in FIG. 26. In (A), schematics are provided, of the colored photonic glass coating structures, which are fabricated by adding dyes to the mixture of the glass microparticles and Al₂O₃ particles. In (B) comparisons are provided, of the solar absorption of the white and colored photonic glass coatings in the solar spectrum. In (C), comparisons are provided, of the averaged solar reflectances of the white and colored photonic glass coatings. The influence of dye concentration on the solar reflectance of colored radiative cooling coatings is provided in FIG. 27. In (a), measured solar reflectances of colored radiative cooling coatings at varying dye concentrations on glass slides are provided. In (b), photographs illustrating the appearance of colored radiative cooling coatings at various dye concentrations are provided. As the mass fraction of the dyes increases from 6.25 wt-% to 25.0 wt-%, the solar reflectance of the coating decreases from 0.943 to 0.905.

These experiments illustrate how, for different types of coating compositions having one or more compositions of solid particles and a given binder system, component amounts and ratios can be engineered to obtain an effective and highly advantageous combination of reflectance and emissivity, together with high adhesive strength, suitable for a broad range of radiative cooling applications. Further considerations in engineering these compositions reside in differences in emission spectra that have been determined for microparticles, exhibiting a relatively broad emission spectrum, as opposed to nanoparticles, exhibiting a relatively narrow emission spectrum. In general, nanoparticles are therefore advantageous in terms of obtaining, in the formed compositions, an emission spectrum within the atmospheric transparency window (8-13 μm). The binders themselves typically exhibit broad emission spectra, such that the extent of their use should be managed.

1. A precursor for forming a radiative cooling composition, the precursor comprising:
(a) solid particles having at least a first composition comprising an inorganic oxide, nitride, carbide, sulfate, or carbonate, and
(b) an inorganic binder-forming liquid or an inorganic binder-forming solid,
wherein when the precursor is applied, optionally following the addition of a solvent in the case of an inorganic binder-forming solid, and subjected to drying to remove all or substantially all of said solvent of the precursor and to form a coating composition having a thickness of 500 μm, said coating has a solar reflectance of at least about 0.80 and a infrared emissivity at least about 0.80 in a wavelength range from 8 μm to 13 μm.

2. The precursor of claim 1, wherein the inorganic binder-forming liquid or inorganic binder-forming solid is a silicate binder-forming liquid or silicate binder-forming solid.

3. The precursor of claim 1, wherein the inorganic binder-forming liquid or inorganic binder-forming solid is present in the precursor, on a solvent-free basis, in an amount from about 10 wt-% to about 60 wt-%.

4. The precursor of claim 1, wherein the solid particles having the first composition comprise an inorganic oxide.

5. The precursor of claim 4, wherein the inorganic oxide is selected from the group consisting of Al₂O₃, SiO₂, ZnO, TiO₂, and MgO.

6. The precursor of claim 1, wherein the solid particles having the first composition have an average particle size from about 0.1 μm to about 20 μm.

7. The precursor of claim 2, wherein the silicate binder-forming liquid comprises an alkali metal silicate solution or alkaline earth metal silicate solution, and wherein the precursor is a slurry.

8. The precursor of claim 7, wherein the slurry has a total solids content of at least about 5 wt-%.

9. The precursor of claim 1, wherein the silicate binder-forming solid is sodium silicate.

10. The precursor of claim 1, wherein component (b) is a silicate binder-forming solid, and wherein the composition further comprises a solvent.

11. The precursor of claim 10, wherein the solvent comprises water, a hydrocarbon, or an oxygenated hydrocarbon.

12. The precursor of claim 1, further comprising solid particles having a second composition different from the first composition.

13. The precursor of claim 12, wherein the solid particles having the first composition and the solid particles having the second composition are present in the precursor in a first composition:second composition weight ratio from about 100:1 to about 1:100.

14. The precursor of claim 12, wherein the solid particles having the second composition have an average particle size from about 0.5 μm to about 20 μm.

15. The precursor of claim 12, wherein the second composition is a glass.

16. The precursor of claim 15, wherein the glass has a softening temperature of less than about 500° C.

17. A precursor for forming a radiative cooling composition, the precursor comprising:
(a) solid particles having a first composition comprising an inorganic oxide, nitride, carbide, sulfate, or carbonate, and
(b) solid particles having a second composition different from the first composition, wherein the second composition is a glass, and
(c) optionally a solvent comprising water, a hydrocarbon, or an oxygenated hydrocarbon,
wherein the solid particles having the first composition are particles having an average particle size from about 0.1 μm to about 20 μm, and wherein the solid particles having the second composition have an average particle size from about 0.5 μm to about 20 μm.

18. A method for forming a coating composition on a substrate, the method comprising:
(a) applying the precursor of claim 1 to the substrate, optionally following combining the precursor with a solvent and/or optionally wherein the precursor has been subjected to mixing, and
(b) drying the precursor, or allowing the precursor to dry,
to form the coating composition.

19. A method for forming a coating composition on a substrate, the method comprising:
(a) applying the precursor of claim 17 to the substrate, optionally following combining the precursor with a solvent and/or optionally wherein the precursor has been subjected to mixing, and
(b) heating the precursor to a temperature that is at or above a softening temperature of the second composition.

20. A coating composition formed by the method claim 19.
